(19) United States
(12) Patent Application Publication
(10) Pub. No.: US 2026/0363159 A1
(43) Pub. Date: Nov. 19, 2026

(54) CONTROL SYSTEM, WORK VEHICLE, CONTROL METHOD, AND COMPUTER PROGRAM

(71) Applicant: Kubota Corporation, Osaka (JP)

(72) Inventors: Shuya KAECHI, Sakai-shi (JP); Takashi ISHIZAKI, Sakai-shi (JP); Natsumi WADA, Sakai-shi (JP)

(21) Appl. No.: 19/721,142

(22) Filed: Jun. 26, 2026

Related U.S. Application Data
(63) Continuation of application No. PCT/JP2024/038270, filed on Oct. 28, 2024.

(30) Foreign Application Priority Data
Dec. 28, 2023 (JP) 2023-223426

(51) Int. Cl. A01B 71/02; B60K 35/10; B60K 35/215

(52) U.S. Cl. CPC A01B 71/02; B60K 35/10; B60K 35/215; B60K 2360/137

(57) ABSTRACT

A control system for a work vehicle includes a controller configured or programmed to control a predetermined device included in the work vehicle, and a meter panel including a digital display. The controller is configured or programmed to cause the digital display to display a setting value of the predetermined device. The controller, when a user performs an operation of a selector to change the setting value, detects a speed at which the selector moves by the user's operation, and changes an amount of change in the setting value per predetermined displacement amount of the selector according to the detected speed.

### CROSS REFERENCE TO RELATED APPLICATIONS

This application claims the benefit of priority to Japanese Patent Application No. 2023-223426 filed on Dec. 28, 2023 and is a Continuation Application of PCT Application No. PCT/JP2024/038270 filed on Oct. 28, 2024. The entire contents of each application are hereby incorporated herein by reference.

### BACKGROUND OF THE INVENTION

### 1. Field of the Invention

The present disclosure relates to control systems, work vehicles, control methods, and computer programs.

### 2. Description of the Related Art

Research and development of smart agriculture that uses information and communication technology (ICT) and the Internet of things (IoT), as the next-generation agriculture, is under way. Automated and unmanned operations of agricultural machines such as tractors used in fields have been studied and developed. For example, work vehicles that travel while performing automatic steering, using a positioning system such as a global navigation satellite system (GNSS) that can perform precise positioning, have been put into practice.

A meter panel that displays and notifies an operator of a travel speed, an engine load state, and the state of each portion of a work vehicle is provided in front of the operator's seat of an agricultural work vehicle such as a tractor.

Japanese Laid-Open Patent Publication No. 2012-32209 describes a commonly used meter panel for passenger cars.

### SUMMARY OF THE INVENTION

A meter panel provided in an agricultural machine such as a tractor is required to accurately notify the operator of various kinds of information about the vehicle when the vehicle is traveling or working. In addition, it is necessary to display more kinds of information in order to allow such an agricultural machine to perform various kinds of works outdoors compared to general passenger cars. In the case in which an agricultural machine is used in smart agriculture, even more kinds of information need to be displayed. However, as the amount of information displayed on the meter panel increases, visibility decreases, and therefore, it is more difficult for the operator to obtain necessary information.

Also, an increased demand for such a meter panel is not only for agricultural machines but also for construction machines that are used in work in construction sites. Agricultural machines and construction machines that can travel are hereinafter collectively referred to as “work vehicles”.

Example embodiments of the present disclosure provide control systems, work vehicles including such control systems, and control methods.

The present disclosure provides solutions described in the following example embodiments.

### Item 1

A control system for a work vehicle including a controller configured or programmed to control a predetermined device included in the work vehicle, and a meter panel including a digital display, wherein the controller is configured or programmed to cause the digital display to display a setting value of the predetermined device, the controller is configured or programmed to, when a user performs an operation of a selector to change the setting value, detect a speed at which the selector moves by the user's operation, and change an amount of change in the setting value per predetermined displacement amount of the selector according to the detected speed.

### Item 2

The control system of item 1, wherein the controller is configured or programmed to make the amount of change in the setting value per the predetermined displacement amount of the selector larger when the detected speed is a first speed than when the detected speed is a second speed that is smaller than the first speed.

### Item 3

The control system of item 1 or 2, wherein the work vehicle includes a first device and a second device as the predetermined device, and the controller is configured or programmed to make the amount of change in the setting value per the predetermined displacement amount of the selector for a same speed at which the selector moves different between a case in which the setting value of the first device is changed and a case in which the setting value of the second device is changed.

### Item 4

The control system of any one of items 1 to 3, wherein the selector is a rotary selector rotatable by the user to perform an operation, and the controller is configured or programmed to detect an angular velocity of the rotary selector, and change an amount of change in the setting value per rotation of the rotary selector by a predetermined angle according to the detected angular velocity.

### Item 5

The control system of item 4, wherein the rotary selector is a jog dial.

### Item 6

The control system of item 4 or 5, wherein the controller is configured or programmed to cause the digital display to display a first graph with a value that increases or decreases along a circumference or an arc, and change a display content of the first graph according to a change in the setting value.

### Item 7

The control system of any one of items 4 to 6, wherein the rotary selector includes a push-button switch, and the controller is configured or programmed to cause the digital display to display a switch image corresponding to the push-button switch, and change a display content of the switch image according to an operation of the push-button switch by the user.

### Item 8

The control system of any one of items 4 to 7, wherein the controller is configured or programmed to cause the digital display to display a plurality of options to set a mode, and change, according to an operation of the user to rotate the rotary selector, a candidate option to be selected among the plurality of options.

### Item 9

The control system of item 8, wherein a content set in the work vehicle differs for each of the plurality of options, and the controller is configured or programmed to cause the digital display to display setting content information indicating the content to be set in the work vehicle for each of the plurality of options.

### Item 10

The control system of item 9, wherein the controller is configured or programmed to cause the digital display to display the setting content information such that a display position of the setting content information is adjacent to a display position of the corresponding option.

### Item 11

The control system of any one of items 4 to 10, wherein the predetermined device is an engine controller configured or programmed to operate an engine and change a rotation speed of the engine, and the controller is configured or programmed to cause the digital display to display an image to set the engine rotation speed, and change the engine rotation speed according to an operation of the user to rotate the rotary selector.

### Item 12

The control system of item 11, wherein the controller is configured or programmed to cause the digital display to display the engine rotation speed.

### Item 13

The control system of any one of items 4 to 10, wherein the predetermined device is a transmission controller configured or programmed to operate a transmission and change a gear stage setting and/or sensitivity of the transmission, and the controller is configured or programmed to cause the digital display to display an image to set the gear stage setting and/or sensitivity of the transmission, and change the gear stage setting and/or sensitivity of the transmission according to an operation of the user to rotate the rotary selector.

### Item 14

The control system of item 13, wherein the controller is configured or programmed to cause the digital display to display the gear stage setting and/or sensitivity of the transmission.

### Item 15

The control system of any one of items 4 to 10, wherein the predetermined device is a wiper driver to operate a wiper, the wiper driver is capable of changing a length of a stationary time that is a time during which the wiper is stationary between one operation of the wiper and the next operation thereof, and the controller is configured or programmed to cause the digital display to display an image to set the stationary time, and change the length of the stationary time according to an operation of the user to rotate the rotary selector.

### Item 16

The control system of item 15, wherein the controller is configured or programmed to cause the digital display to display the length of the stationary time.

### Item 17

The control system of items 15 or 16, wherein the controller is configured or programmed to cause the digital display to display a second graph with a value that increases or decreases along a circumference or an arc, and change a display content of the second graph according to a change in the length of the stationary time.

### Item 18

A work vehicle including the control system of any one of items 1 to 17.

### Item 19

The work vehicle of item 18, wherein the work vehicle is a mobile agricultural machine.

### Item 20

The work vehicle of item 18, wherein the work vehicle is a tractor.

### Item 21

A computer-implemented control method to control a work vehicle executed by one or more computers, the method including causing a digital display of a meter panel to display a setting value of a predetermined device included in the work vehicle, and when a user performs an operation of a selector to change the setting value, detecting a speed at which the selector moves by the user's operation, and changing an amount of change in the setting value per predetermined displacement amount of the selector according to the detected speed.

### Item 22

A non-transitory computer-readable medium including a computer program that causes one or more computers to execute control of a work vehicle, the computer program causing the one or more computers to perform causing a digital display of a meter panel to display a setting value of a predetermined device included in the work vehicle, and when a user performs an operation of a selector to change the setting value, detecting a speed at which the selector moves by the user's operation, and changing an amount of change in the setting value per predetermined displacement amount of the selector according to the detected speed.

General or specific example embodiments of the present disclosure may be implemented using a device, system, method, integrated circuit, computer program, non-transitory computer-readable storage medium, or any combination thereof. The computer-readable storage medium may be inclusive of volatile and non-volatile storage media. A device may include a plurality of devices. In the case in which a device includes two or more devices, the two or more devices may be provided in a single apparatus, or separately arranged in two or more different apparatuses.

According to example embodiments of the present disclosure, information display systems capable of displaying various kinds of information required for agricultural work with good visibility, control systems used in the information display systems, control methods, work vehicles including such information display systems or control systems, and display methods for displaying images, are provided.

The above and other elements, features, steps, characteristics and advantages of the present invention will become more apparent from the following detailed description of the example embodiments with reference to the attached drawings.

### BRIEF DESCRIPTION OF THE DRAWINGS

FIG. 1A is a side view schematically illustrating an example work vehicle 200 according to an example embodiment of the present disclosure.

FIG. 1B is a diagram illustrating an example of a group of operation switches and an operation terminal provided inside a cabin of a work vehicle.

FIG. 1C is a side view schematically illustrating another example work vehicle according to an example embodiment of the present disclosure.

FIG. 1D is a front view schematically illustrating a meter panel in a state of being attached behind a steering wheel positioned in front of an operator's seat of a work vehicle, in an example embodiment of the present disclosure.

FIG. 2 is a front view illustrating an example arrangement of main components of the meter panel of this example embodiment of the present disclosure.

FIG. 3 is a perspective view illustrating an example configuration of a wall surface portion of the meter panel of this example embodiment of the present disclosure.

FIG. 4 is a perspective view illustrating an example configuration of a transparent cover of the meter panel of this example embodiment of the present disclosure.

FIG. 5 is a front view illustrating an example arrangement of indicators of the meter panel of this example embodiment of the present disclosure.

FIG. 6 is a front view illustrating an example state in which various kinds of information are displayed on a display of the meter panel of this example embodiment of the present disclosure.

FIG. 7 is a perspective view of an analog meter in the meter panel of this example embodiment of the present disclosure.

FIG. 8 is a front view illustrating a positional relationship between a first analog meter, an arc-shaped indicator, and a facing plate.

FIG. 9 is a front view illustrating an example configuration of an arc-shaped indicator.

FIG. 10 is a front view illustrating a second analog meter and a second arc-shaped indicator.

FIG. 11 is a block diagram schematically illustrating an example configuration of an information display system in an example embodiment of the present disclosure.

FIG. 12 is a block diagram illustrating an example hardware configuration of a controller.

FIG. 13 is a diagram illustrating an example in which a controller is implemented inside a meter panel.

FIG. 14A is a front view schematically illustrating an example in which an arc with the same color as that of light emitted from a light emitting region of an arc-shaped indicator is displayed.

FIG. 14B is a front view schematically illustrating an example in which an arc with the same color as that of light emitted from a light emitting region of an arc-shaped indicator, and another object having an arc with the same color, are displayed.

FIG. 15 is a diagram illustrating an example of a home screen.

FIG. 16 is a diagram schematically illustrating an example of segmentation of a display region.

FIG. 17 is a block diagram schematically illustrating a part of a configuration of a work vehicle including a control system according to an example embodiment of the present disclosure.

FIG. 18 is a diagram schematically illustrating an example of display on a display of a meter panel in a control system according to an example embodiment of the present disclosure.

FIG. 19 is a diagram schematically illustrating an example of display on a display of a meter panel in a control system according to an example embodiment of the present disclosure.

FIG. 20 is a diagram schematically illustrating an example of display on a display of a meter panel in a control system according to an example embodiment of the present disclosure.

FIG. 21A is a diagram schematically illustrating an example of display on a display of a meter panel in a control system according to an example embodiment of the present disclosure.

FIG. 21B is a diagram schematically illustrating an example of display on a display of a meter panel in a control system according to an example embodiment of the present disclosure.

FIG. 21C is a diagram schematically illustrating an example of a lookup table referenced by a controller of a control system according to an example embodiment of the present disclosure.

FIG. 22A is a perspective view illustrating an example of an external appearance of a work vehicle.

FIG. 22B is a diagram schematically illustrating an example of display on a display of a meter panel in a control system according to an example embodiment of the present disclosure.

### DETAILED DESCRIPTION OF THE EXAMPLE EMBODIMENTS

Meter panels according to example embodiments of the present disclosure will be described below with reference to the accompanying drawings. It should be noted that like reference signs refer to like elements, components, features, etc., throughout the several views.

The example embodiments described below are exemplified to embody technical ideas of the present invention, and the present invention is not limited to the following. Furthermore, the descriptions of sizes, materials, shapes, relative arrangements, and the like of elements, components, features, etc., are not intended to limit the scope of the present invention thereto but intended to be illustrative. The size and positional relationship of elements, components, features, etc., illustrated in the drawings may be exaggerated to facilitate understanding.

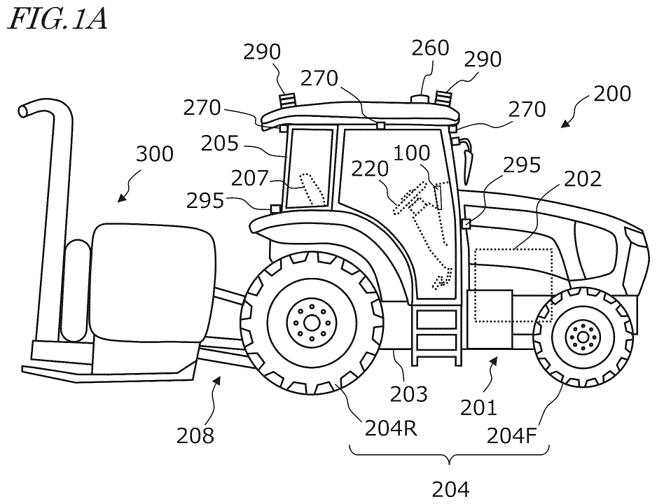

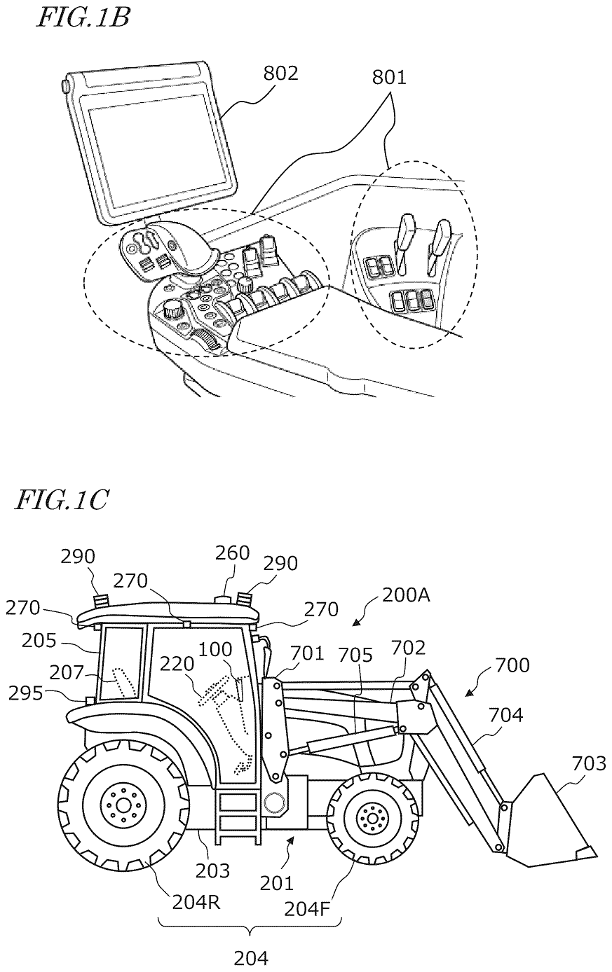

FIG. 1A is a side view schematically illustrating an example work vehicle 200 according to this example embodiment. The illustrated work vehicle 200 is a tractor that tows an implement (replaceable work equipment) 300.

The work vehicle 200 of FIG. 1A includes a vehicle body 201, a prime mover (engine) 202, and a transmission 203. The vehicle body 201 is provided with a travel device including tire-mounted wheels 204, and a cabin 205. The travel device includes four wheels 204, axles to rotate the four wheels, and brakes to slow or stop the axles. The wheels 204 of this example include a pair of front wheels 204F and a pair of rear wheels 204R. One or both of the front wheels 204F and the rear wheels 204R may be replaced by a plurality of wheels to which a continuous track is attached (crawler) instead of a tire-mounted wheel.

In the cabin 205, a meter panel 100 according to an example embodiment of the present disclosure, an operator's seat 207, a steering wheel 220, and switches for operations are provided.

FIG. 1B is a diagram illustrating an example of a group of operation switches 801 and an operation terminal 802 provided inside the cabin 205 of the work vehicle 200.

In the interior of the cabin, a group of operation switches 801 including a plurality of switches operable by the user is arranged. The group of operation switches 801 includes, for example, switches to select the gear stage of the main transmission or sub-transmission, a switch to switch between forward and reverse travel, a switch to switch between four-wheel drive and two-wheel drive, a switch to release the coupling of the left and right brakes, and switches to operate the implement.

The operation terminal 802 is a terminal for the user to perform operations relating to the travel of the work vehicle and the operation of the implement, and is also referred to as a virtual terminal (VT). The operation terminal 802 may include a touch screen display device and/or one or more buttons. The display device may be, for example, a liquid crystal or organic light emitting diode (OLED) display.

Referring again to FIG. 1A. The work vehicle 200 of FIG. 1A is provided with a plurality of external sensors to sense surroundings of the work vehicle 200. The external sensors may include various kinds of sensors such as a plurality of cameras 270, a plurality of obstacle sensors 295, and a plurality of LiDAR sensors 290. The cameras 270 may, for example, be provided on the front, rear, left, and right sides of the work vehicle 200. Each camera 270 captures an image of an environment around the work vehicle 200, and generates image data. Images obtained by the cameras 270 may, for example, be transmitted to a terminal device for remote monitoring. The cameras 270 are optionally provided, and the number thereof is not particularly limited. The LiDAR sensor 290 is an example external sensor to output sensor data indicating a distribution of objects present in an environment around the work vehicle 200. In the example of FIG. 1A, two LiDAR sensors 290 are provided at an upper front portion and an upper rear portion of the cabin 205. The LiDAR sensors 290 may be provided at other positions (e.g., a lower portion of a front surface of the vehicle body 201). Each LiDAR sensor 290 repeatedly outputs sensor data indicating distances to and directions of measurement points of objects existing in a surrounding environment, or the three-dimensional coordinate values of the measurement points, while the work vehicle 200 is traveling. The number of LiDAR sensors 290 is not limited to two and may be one or at least three, for example. In the example of FIG. 1A, the plurality of obstacle sensors 295 are provided at a front portion and a rear portion of the cabin 205. The obstacle sensors 295 may be positioned at other positions. The obstacle sensors 295 may include a laser scanner or ultrasonic sonar, for example. The LiDAR sensors 290 and the obstacle sensors 295 may be activated, for example, when the work vehicle 200 travels in an automatic driving mode. The LiDAR sensors 290 and obstacle sensors 295 are optionally provided, and the number of each is not particularly limited. Only one of the LiDAR sensors 290 and obstacle sensors 295 may be provided in the work vehicle 200. In cases where they are not needed, such as when the work vehicle 200 does not have an automatic driving function, the work vehicle 200 need not include the LiDAR sensors 290 and the obstacle sensors 295.

The work vehicle 200 further includes a GNSS unit 260. GNSS collectively refers to satellite-based positioning systems, such as the global positioning system (GPS), the quasi-zenith satellite system (QZSS, for example, Michibiki), GLONASS, Galileo, and BeiDou. The GNSS unit 260 receives satellite signals transmitted from a plurality of GNSS satellites (also referred to as GNSS signals), and performs positioning based on the satellite signals. The GNSS unit 260 is provided at an upper portion of the cabin 205, but the GNSS unit 260 may be provided at other positions.

The engine 202 may, for example, be a diesel engine. An electric motor may be used instead of a diesel engine. The transmission 203 is capable of changing the propelling force and movement speed of the work vehicle 200 by changing gear ratios. The transmission 203 is also capable of allowing the work vehicle 200 to switch between forward movement and rearward movement.

A connector 208 is provided at a rear portion of the vehicle body 201. The connector 208 includes, for example, a three-point support device (also referred to as a “three-point linkage” or “three-point hitch”), a power take-off (PTO) shaft, a universal joint, and a communication cable. The connector 208 can be used to removably connect an implement 300 to the work vehicle 200. The connector 208 can change the position or orientation of the implement 300 by raising or lowering the three-point linkage using, for example, a hydraulic device. In addition, power can be transmitted from the work vehicle 200 to the implement 300 through the universal joint. While towing the implement 300, the work vehicle 200 allows the implement 300 to perform predetermined work. A connector may also be provided at a front portion of the vehicle body 201. In that case, an implement can be connected in front of the work vehicle 200.

Although the implement 300 of FIG. 1A is, for example, a sprayer for spraying a chemical agent to crops, the implement 300 is not limited to sprayers. For example, any kind of implement 300 such as a mower, seeder, spreader, rake, baler, harvester, plough, harrow, or rotary tiller may be connected to the work vehicle 200 for use.

Thus, the work vehicle 200, which is used in smart agriculture, includes various sensors, and performs various kinds of work together with the implement 300. During such work, it is necessary to give the driver (user or operator) various kinds of information about a travel state and a work state. Therefore, information that should be displayed on the meter panel 100 may significantly vary depending on the kind and phase of work.

It should be noted that the work vehicle 200, such as a tractor, may be configured to travel by manual driving, automatic steering, or automatic driving.

Another example of an implement in the present example embodiment is a loader including a tip to which an attachment is detachably attached. Various attachments suited to the nature of the work are attached to the tip of the loader. The attachments are, for example, grabs such as bale grabs and silage grabs, forks such as roll forks and super pallet forks, or buckets.

FIG. 1C is a side view schematically illustrating an example work vehicle 200A according to this example embodiment. The illustrated work vehicle 200A is a tractor to the front of which a front loader (hereinafter simply referred to as a “loader”) 700 is connected. A bucket 703 is attached as an attachment to the tip of the loader 700. It should be noted that the loader of the present example embodiment is not limited to a front loader, and may be a loader connected to the rear of the vehicle.

The loader 700 illustrated in FIG. 1C includes a support frame 701, a boom 702, a bucket 703, a bucket cylinder 704, and a boom cylinder 705. The loader 700 further includes a microcontroller 710 (see FIG. 11) that controls the operation of the loader. The support frame 701 is fixed to the frame of the vehicle body 201. The boom 702 has an arm-shaped structure and is rotatably supported by the support frame 701 so as to extend forward and upward of the vehicle. The bucket 703 is rotatably supported by an end portion of the boom 702. In the present example embodiment, the fulcrum (or rotational axis) that rotatably supports the boom 702 is referred to as the “boom fulcrum,” and the fulcrum (or rotational axis) that rotatably supports the bucket 703 is referred to as the “bucket fulcrum.”

The loader 700 in the present example embodiment is connected to the vehicle body 201 via a hydraulic coupler and a power connector. The loader 700 includes a hydraulic system having hydraulic valves, and operates under hydraulic control. Specifically, by extending and retracting the boom cylinder 705 hydraulically, the boom 702 can be rotated around the rotational axis located at the boom fulcrum. This makes it possible to raise and lower the loader 700 (or bucket 703). In addition, by extending and retracting the bucket cylinder 704 hydraulically, the bucket 703 can be rotated around the rotational axis located at the bucket fulcrum. This enables scooping and dumping operations of the bucket 703.

The group of operation switches 801 (see FIG. 1B) provided inside the cabin 205 may include an operation lever for performing dump and scoop operations of the bucket 703. An operation joystick for performing dump, scoop, and lift operations of the bucket 703 may be provided inside the cabin 205. In addition, the operation terminal 802 may display a setting screen for the hydraulic control valve of the loader, including a button display for adjusting the flow rate of hydraulic fluid. The operation lever, joystick, and operation terminal 802 are electrically connected to the microcontroller of the loader. The user can perform desired work while operating the boom 702 and bucket 703 by operating the operation lever, joystick, and the setting screen of the operation terminal 802.

FIG. 1D is a front view schematically illustrating the meter panel 100 when the meter panel 100 is attached to a tractor, which is an example work vehicle, in an example embodiment of the present disclosure. In the example illustrated in FIG. 1D, the meter panel 100 is positioned on the front side of the operator's seat of the tractor. Specifically, the meter panel 100 is positioned above a steering column (steering wheel stay) 230 that supports the steering wheel 220 in a manner that allows the steering wheel 220 to rotate, and is fitted into an opening of a meter cover 240. In this example, the steering wheel 220 has a central hub (horn cover) 221, three spokes 222A, 222B, and 222C radially extending from the horn cover 221, and a rim 223 supported by the spokes 222A, 222B, and 222C. The meter panel 100 is provided at a position that allows the operator sitting on the operator's seat to see the meter panel 100. In the example of FIG. 1D, various kinds of information displayed on the meter panel 100 can be seen through an opening between the spokes 222A and 222B.

The meter panel 100 is required to have excellent visibility. In particular, in the case of movable work vehicles capable of performing automatic steering or automatic driving, various kinds of information that are not displayed on general passenger cars need to be displayed during various kinds of agricultural work. For the meter panel 100, having such a feature, the visibility is preferably improved so as to avoid overlooking more important information of various kinds of information. In addition, in the case in which the meter panel 100 is mounted on various work vehicles, it is desirable that the meter panel 100 have a structure that allows easy attachment. As described below, the meter panel 100 of this example embodiment has excellent visibility and is easy to attach.

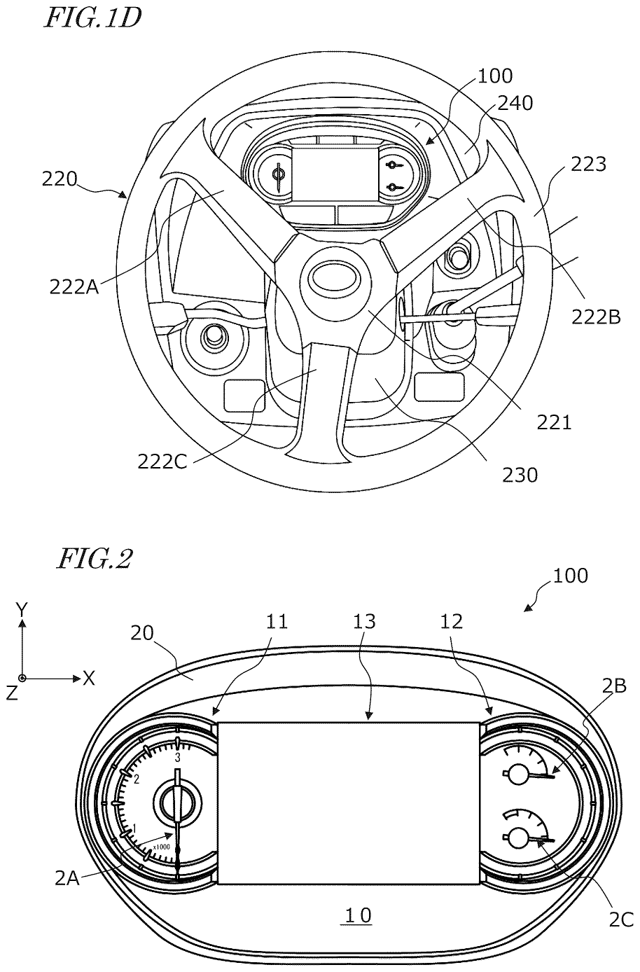

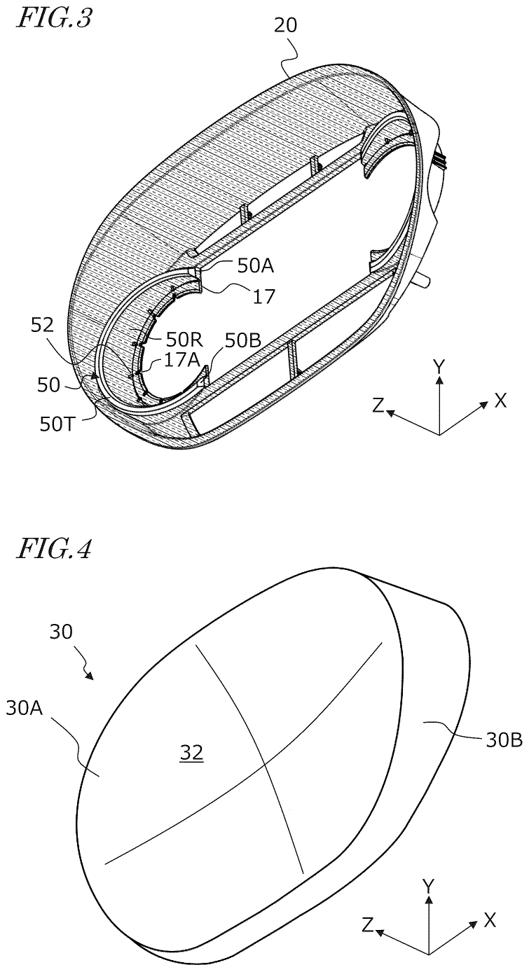

An overall configuration of the meter panel 100 will be described below with reference to FIGS. 2, 3, and 4. FIG. 2 is a front view illustrating an example arrangement of main components of the meter panel 100 of this example embodiment. FIG. 3 is a perspective view illustrating an example configuration of a wall surface portion described below of the meter panel 100. FIG. 4 is a perspective view illustrating an example configuration of a transparent cover described below of the meter panel 100. These drawings illustrate an X-axis, a Y-axis, and a Z-axis that are orthogonal to one another for reference (right-handed coordinate system). In the present description, the positive direction of the Y axis is also referred to as “upward,” and the negative direction thereof is also referred to as “downward.” The positive direction of the X axis is also referred to as “rightward,” and the negative direction thereof is also referred to as “leftward.” The positive direction of the Z axis is also referred to as “forward,” and the negative direction thereof is also referred to as “backward.”

As illustrated in FIG. 2, the meter panel 100 includes a meter portion 10 including a first analog meter 11, a second analog meter 12, and a display (i.e., digital display) 13 provided between the first and second analog meters 11 and 12. In the present description, a portion of the meter portion 10 of FIG. 2 that displays information is also referred to as a display surface side of the meter portion 10.

The first analog meter 11 includes a pointer 2A, and the second analog meter 12 includes pointers 2B and 2C. The pointer 2A is supported in a manner that allows the pointer 2A to rotate around a rotation axis positioned near the center of the first analog meter 11. The pointer 2A indicates the engine speed by the direction in which the tip of the pointer 2A is oriented, for example. Here, “engine speed” may be the number of revolutions of the engine per unit time (for example, one minute). The pointers 2B and 2C are supported in a manner that allows the pointers 2B and 2C to rotate around the respective axes of rotation located at different positions of the second analog meter 12. The pointer 2B indicates the remaining amount of fuel by the direction in which the tip of the pointer 2B is oriented. The pointer 2C indicates the temperature (water temperature) of engine-cooling water by the direction in which the tip of the pointer 2C is oriented, for example. The pointers 2A, 2B, and 2C are driven by a driver (movement) included in the meter portion 10. The driver receives an electrical signal indicating a sensor output such as the engine speed, the remaining amount of fuel, or the water temperature, and converts the electrical signal into mechanical movements for changing the orientations of the pointers 2A, 2B, and 2C. The driver for each pointer 2A, 2B, 2C includes an actuator such as a stepping motor.

The display 13 is a digital meter rather than an analog meter. The display 13 is, for example, an active matrix display, such as a liquid crystal display panel or an organic light emitting diode (OLED). In the following description, as an example, it is assumed that the display 13 is a liquid crystal display (LCD). The display 13 includes a large number of pixels two-dimensionally arranged in a display region, and provides display visible to the human eye by emitting light from the large number of pixels. In this example embodiment, each pixel of the display 13 includes R, G, and B subpixels, and therefore, the display 13 is capable of displaying color images. Unlike analog meters, the display 13 is capable of displaying numerals, letters, graphics, icons, symbols, still images, or moving images having any appropriate sizes at any appropriate positions in the display region. Strictly speaking, numerals, letters, graphics, icons, and symbols are a part of images (still images or moving images) displayed in the display region by the display 13. The display 13 is also capable of apparently displaying an image similar to all or a portion of an analog meter having a pointer. In the case in which the display 13 displays an image of an “analog meter,” a “pointer” in the image can be turned in any appropriate direction as a portion of moving images, by changing images on a frame-by-frame basis. It should be noted that in the case in which the work vehicle is an electric vehicle that is driven by a battery, the display of the engine speed, the remaining amount of fuel, and the water temperature may, for example, be replaced by the display of a motor output, the state of charge of the battery, and the temperature of the battery, respectively.

The “analog meter” displayed by a display device such as the display 13 is different from the first analog meter 11 and the second analog meter 12 in that the former is two-dimensional and the latter is three-dimensional. In addition, whereas the shape, color, and size of the pointer and scales of the former analog meter are changeable, it is difficult to change those of the latter. Furthermore, the visibility of the former depends on the contrast of an image, and therefore, is likely to decrease during the daytime, when external light is strong, whereas such a problem with the latter is relatively small. With the above in mind, in this example embodiment, a portion of information displayed in the meter portion 10, particularly information with high importance and requiring high visibility, is displayed using an analog meter having a three-dimensional structure.

An external shape of the meter portion 10 when the meter portion 10 is viewed from the front of the display surface side is a closed loop similar to an ellipse. The external shape of the meter portion 10 is not limited to such an example. The external shape of the meter portion 10 when the meter portion 10 is viewed from the front may have generally a rectangular shape, or a shape that is a combination of a straight line and a curved line.

The meter panel 100 further includes a wall surface portion 20 fixed to the display surface side of the meter portion 10, and a transparent cover 30 opposite the display surface of the meter portion 10.

The wall surface portion 20 surrounds the first analog meter 11, the display 13, and the second analog meter 12 entirely along the peripheral edge of the meter portion 10. The wall surface portion 20 may, for example, be formed of a plastic (synthetic resin). The wall surface portion 20 protrudes vertically (the positive direction of the Z axis) from the display surface of the meter portion 10. The wall surface portion 20 does not necessarily need to be perpendicular to the display surface of the meter portion 10, and may be tilted from the Z axis. In the present disclosure, the distance between the display surface of the meter portion 10 and an end on the front side of the wall surface portion 20 is referred to as a “height” of the wall surface portion 20. In this example embodiment, the height of the wall surface portion 20 is not uniform along the peripheral edge of the meter portion 10, and may vary depending on the position on the peripheral edge.

As illustrated in FIG. 4, the transparent cover 30 includes a front surface section 30A including a concave surface 32, and a side surface section 30B extending from the peripheral edge of the front surface section 30A along the outer side of the wall surface portion 20. The side surface section 30B of the transparent cover 30 can cover the outer side of the wall surface portion 20 along all the periphery thereof. The transparent cover 30 may, for example, be made of a colorless, transparent plastic (e.g., acrylic resin), or glass. In this example embodiment, the front surface section 30A and the side surface section 30B of the transparent cover 30 are integrally formed together.

When the transparent cover 30 is viewed from the direction of the normal to the meter portion 10 with the meter panel 100 attached to the work vehicle, the front surface section 30A of the transparent cover 30 is preferably tilted forward toward the operator. In the case in which the front surface section 30A is tilted forward, when the operator sees the meter portion 10 through the transparent cover 30, the operator's face and the background behind the operator are less likely to be reflected on the transparent cover 30.

Next, an indicator region of the meter portion 10 will be described with reference to FIG. 5. In the example of FIG. 5, the meter portion 10 includes an indicator region 14T provided above the display 13, and indicator regions 14L and 14R provided below the display 13. Various indicators are provided in each of the indicator regions 14T, 14L, and 14R. Each indicator presents predetermined information such as warning when a light emitting device such as a light emitting diode (LED) behind the indicator is on.

It should be noted that in this example embodiment, two indicator regions 14L and 14R that are divided left and right are arranged below the display 13, but one indicator region that integrates the two indicator regions may be arranged.

Visibility of the indicator region 14T, which is positioned above the display 13, is less likely to be obstructed by the spokes 222A, 222B, and 222C of the steering wheel 220, compared to the other indicator regions 14L and 14R. Therefore, it is preferable that indicators for indicating particularly important information (information with a higher warning level) (e.g., indicators for indicating the on/off state of the illumination device, turn signals, and warnings to the operator) be selected from a large number of indicators and arranged in the indicator region 14T. The “warning level” of information displayed by an indicator may, for example, be specified in the manual of the work vehicle. For example, information such as the abnormality or failure of the engine and the on/off state of the headlamp has a higher warning level.

In this example embodiment, each indicator arranged in the indicator region is composed of a light transmission region having a shape that defines a characteristic graphic (including icons and/or letters) and a light emitting device arranged behind the light transmission region. The indicator may be turned on/off by the light emitting device behind the indicator being turned on/off. One or two light emitting devices are arranged behind each indicator, for example.

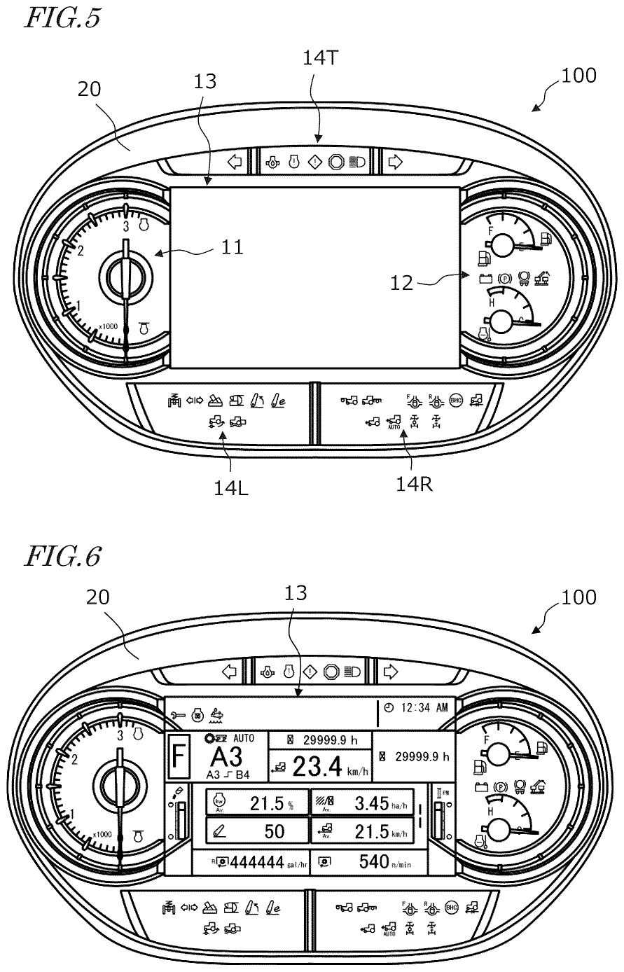

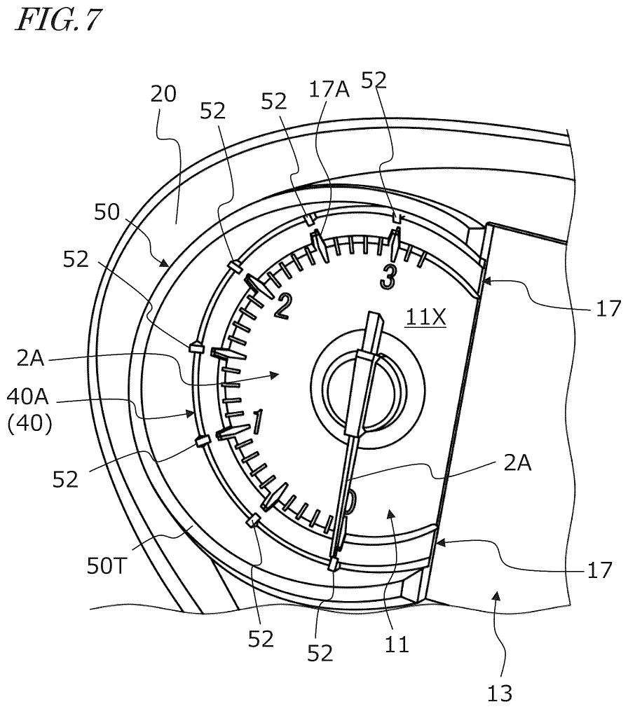

Next, an example display of the display 13 will be described with reference to FIG. 6. In the example of FIG. 6, the display region of the display 13 is divided into several regions as described below. In each region, an “image” showing information such as the gear ratio, vehicle speed, various functional performance information, or hour meter is displayed. The images include various kinds of information represented by letters, numerals, graphics, icons, symbols, and the like. Various kinds of digital images may be indicated by different colors in order to increase the visibility. In particular, when the operator's attention should be attracted, display may be performed in which at least one of the positions, sizes, or colors of letters, numerals, graphics, icons, or symbols are changed and emphasized. When such emphasized display is performed, sound or speech may be emitted from an audio device such as a loudspeaker.

Next, an arc-shaped indicator (C-shaped communication ring) and a facing plate will be described with reference to FIGS. 7 to 9.

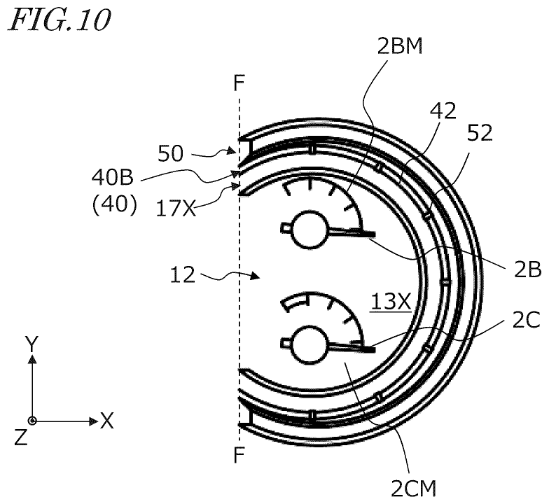

In this example embodiment, the meter panel 100 includes a first arc-shaped indicator (communication ring) 40A arranged around a sweep range 11X of the pointer 2A, and a second arc-shaped indicator 40B (see FIG. 10) arranged around sweep ranges of the pointers 2B and 2C. In the present disclosure, the term “arc” means a portion of a circle (circumference). The circle is not limited to a “perfect circle,” and may include a portion whose curvature is gradually or locally changed like a portion of an ellipse.

The structure of the first arc-shaped indicator 40A and the structure of the second arc-shaped indicator 40B are symmetrical about a vertical line, and therefore, are collectively referred to as arc-shaped indicators 40. The arc-shaped indicators 40 will be described below using the first arc-shaped indicator (communication ring) 40A as an example, for the sake of simplicity.

As illustrated in FIG. 7, the meter panel 100 of this example embodiment includes a facing plate 50 positioned outward of the arc-shaped indicator 40. The facing plate 50 is formed of the same material (plastic) as that for the wall surface portion 20. As illustrated in FIG. 3, the facing plate 50 is integral with the wall surface portion 20. The facing plate 50 is in the shape of roughly an arc as viewed from the front. A height of an upper end 50T of the facing plate 50 (that is, the distance from the display surface of the meter portion 10) varies continuously from an end 50A on the upper side to an end 50B on the lower side, and is greatest at a middle position. The facing plate 50 is a curved wall rising from the meter portion 10.

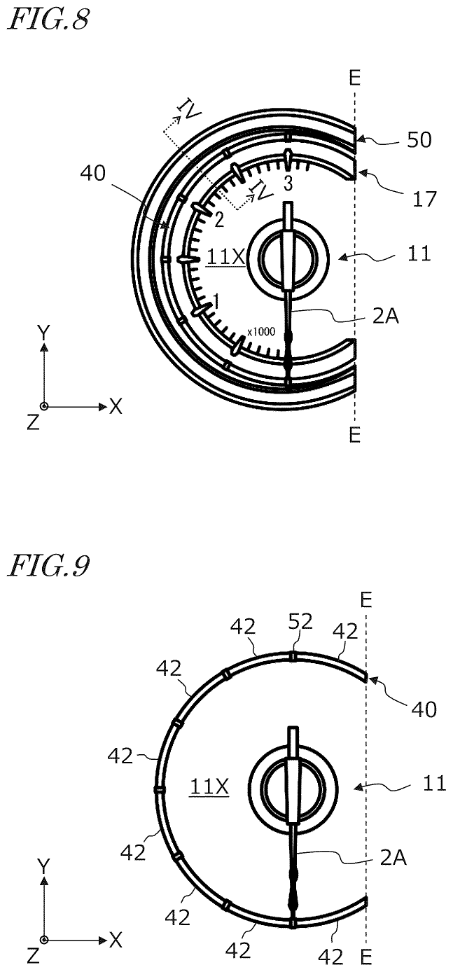

FIG. 8 is a front view illustrating a positional relationship between the first analog meter 11, the arc-shaped indicator 40, and the facing plate 50. FIG. 9 is a front view mainly illustrating an example configuration of the arc-shaped indicator 40. None of the first analog meter 11, the arc-shaped indicator 40, and the facing plate 50 extends rightward (the positive direction of the X axis) beyond a dashed line E-E of FIG. 8. The display 13 is arranged rightward (in the positive direction of the X axis) of the dashed line E-E.

With such a configuration, while the length of the pointer 2A, or the radius of the first analog meter 11, is increased, an increase in the size in the horizontal direction (X-axis direction) of the first analog meter 11 can be reduced. This also holds true for the second analog meter 12. It should be noted that as illustrated in FIG. 1D, when the size in the horizontal direction of the meter portion 10 is increased, the spokes 222A and 222B of the steering wheel 220 are more likely to obstruct seeing of the first and second analog meters 11 and 12. Therefore, it is not preferable to increase the size in the horizontal direction of the meter portion 10. In this example embodiment, the analog meter is contained inside a shape surrounded by the dashed line E-E and an arc rather than a circle. Therefore, even for the meter portion 10, which has a limited size in the horizontal direction, the size in the horizontal direction (X-axis direction) of the display 13 can be increased while the visibility of the first and second analog meters 11 and 12 is increased. In addition, because the first and second analog meters 11 and 12 and the display 13 are separated from each other by a straight line, the display area for analog information and the display area for digital information can be clearly separated from each other, and therefore, the visibility of both analog information and digital information can be improved.

In order to obtain the above effect, it is preferable that the central angle of the “arc” of the arc-shaped indicator 40 (40A), which is arranged, surrounding the first analog meter 11, be greater than 180° and smaller than 270°, for example. If the central angle of the “arc” is at most 180°, the visibility of the first analog meter 11 decreases. If the central angle of the “arc” is at least 270°, for example, the effect of reducing the size in the horizontal direction (X-axis direction) of the first analog meter 11 is not sufficient. This also holds true for the arc-shaped indicator 40 (40B) surrounding the second analog meter 12. In terms of design properties, it is preferable that the left and right arc-shaped indicators 40A and 40B be positioned symmetrically about a vertical line passing through the center of the display 13.

The arc-shaped indicator 40 includes at least one light emitting region 42 between the sweep range 11X of the pointer 2A and the facing plate 50. In the example of FIG. 9, a plurality of light emitting regions 42 are provided. In this example, each light emitting region 42 has a fine curved shape extending along an arc. The plurality of light emitting regions 42 are arranged in a sequence of arcs to provide the arc-shaped indicator 40. In the case in which the number of light emitting regions 42 is one, a single light emitting region 42 has an arc shape.

In the example illustrated in the figure, the first analog meter 11 includes an arc-shaped scale 17 between the arc-shaped indicator 40 and the sweep range 11X of the pointer 2A. The scale 17 has a three-dimensional shape protruding from the display surface (raised scale). The scale 17 is formed of a plastic integrally with the wall surface portion 20 and the facing plate 50. It should be noted that the scale 17 does not necessarily need to have a three-dimensional shape. The scale 17 desirably has a three-dimensional shape in terms of higher visibility.

Although the plurality of light emitting regions 42 included in the arc-shaped indicator 40 may each include a light emitting element (e.g., an LED or OLED), in this example embodiment the plurality of light emitting regions 42 are configured with a plurality of light transmission regions provided on the display surface of the meter portion 10 (i.e., the surface on the front side of the housing of the meter portion 10) and at least one light emitting device arranged behind the plurality of light transmission regions.

The plurality of light emitting devices may include a plurality of LEDs that emit different colors. In this example embodiment, the plurality of light emitting devices include an LED that emits red light, an LED that emits green light, and an LED that emits blue light. By causing these LEDs to selectively emit light, the arc-shaped indicator 40 can exhibit the function of notifying the operator of information using light having various colors. For example, all of the light emitting regions 42 of FIG. 9 can selectively emit red light, green light, and blue light. Alternatively, a light emitting device may be assigned to each of the plurality of light emitting regions 42, and the plurality of light emitting devices may be caused to emit light separately, so that light beams can be sequentially emitted from the plurality of light emitting regions 42.

Next, the raised scale 17 will be described. As illustrated in FIGS. 7 and 8, the raised scale 17 extends in the shape of an arc inside the arc-shaped indicator 40 to form generally a C-shape. As illustrated in FIGS. 3 and 7, the raised scale 17 includes a plurality of notches 17A arranged at predetermined intervals. The notch 17A is a portion of the raised scale 17 whose width is locally reduced. The position of the notch 17A corresponds to the position of a scale that is to be indicated by the tip of the pointer 2A in the first analog meter 11. The presence of the three-dimensional notches 17A facilitates reading of scales by the operator.

As illustrated in FIG. 7, the facing plate 50 includes a plurality of protrusions 52 that protrude toward the sweep range 11X of the pointer 2A. The plurality of protrusions 52 are provided at the positions of the notches of the raised scale 17, or in other words, positions aligned with the scales. Therefore, the notch 17A of the raised scale 17 is recognized as a graphic integrated with the protrusion 52, resulting in an improvement in the visibility of the scale. The plurality of protrusions 52 each extend across between the plurality of light emitting regions 42 of the arc-shaped indicator 40. Therefore, the array of the plurality of light emitting regions 42 also corresponds to the array of the scales.

As can be seen from FIG. 3, the plurality of protrusions 52 serve as a bridge that connects the raised scale 17 to the facing plate 50. The facing plate 50 is connected to the wall surface portion 20. In this example embodiment, the wall surface portion 20, the facing plate 50, and the raised scale 17 are integrally formed of a resin. The plurality of protrusions 52, which extend from the facing plate 50, delimit a boundary portion of the plurality of light emitting regions 42 in the arc-shaped indicator 40.

Next, the second analog meter 12 and the second arc-shaped indicator 40B will be described with reference to FIG. 10. The second arc-shaped indicator 40B and the first arc-shaped indicator 40A are symmetrical about a vertical line, and have substantially the same configuration. A facing plate (right facing plate) 50 is provided outward of the second arc-shaped indicator 40B. The left facing plate 50 and the above facing plate (left facing plate) 50 are symmetrical about a vertical line.

Although an arc-shaped rib 17X corresponding to the raised scale 17 is provided inside the second arc-shaped indicator 40B, no notches are present in the arc-shaped rib 17X. Protrusions (bridges) 52 are equally spaced and arranged between the arc-shaped rib 17X and the right facing plate 50 so as to delimit a plurality of light emitting regions 42 included in the second arc-shaped indicator 40B.

A sweep range 13X of the second pointer 2B and the third pointer 2C is provided in a range surrounded by the second arc-shaped indicator 40B. A rotational angle range 2BM of the second pointer 2B and a rotational angle range 2CM of the third pointer 2C have a similar or congruent outer shape. In the example of FIG. 10, the rotational angle range 2BM of the second pointer 2B and the rotational angle range 2CM of the third pointer 2C are vertically symmetrical, but this is not limited to such an example. The rotational angle range 2BM and the rotational angle range 2CM may have a shape and size such that they overlap each other when one of them is translated in the vertical direction, for example.

With such a configuration, scales can be intuitively read based on the movements of the second pointer 2B and the third pointer 2C, and are less likely to be erroneously read.

An information display system 500 according to an example embodiment of the present disclosure will be described below with reference to FIGS. 11 to 14B. FIG. 11 is a block diagram schematically illustrating an example configuration of the information display system 500 in an example embodiment of the present disclosure. The information display system 500 includes the above meter panel 100, and a controller 400 configured or programmed to control the meter panel 100. The controller 400 may include an electronic control unit (ECU) arranged in the work vehicle. The information display system 500 may further include an audio device such as a buzzer or a speaker.

The information display system 500 is communicably connected via a bus B to an ECU group 610, sensors 620, and a microcontroller 710 of the loader included in the work vehicle. The ECU group 610 may be collectively referred to as a “vehicle controller.” In the present specification, various ECUs included in the work vehicle are referred to as “vehicle ECUs,” and an ECU in the controller 400 included in the information display system 500 is referred to as a “meter ECU” to distinguish between the two. Various vehicle ECUs and the meter ECU can communicate with each other according to a vehicle bus standard such as CAN (controller area network), for example. For example, one vehicle ECU among the ECU group 610 included in the work vehicle receives signals from other vehicle ECUs and sensor data output from each sensor included in the sensors 620, and instructs the meter ECU to display warning messages as described below or to turn on/off/blink indicators according to the state of the work vehicle. The meter ECU receives instructions from the vehicle ECU and causes warning messages to be displayed in the display region or causes indicators to be turned on or off, or to blink.

In FIG. 11, illustration of wiring other than the wiring of the bus B is simplified. However, for example, there may be wiring for directly transmitting signals from one or more sensors included in the sensors 620 included in the work vehicle to the controller 400, or wiring connecting an input device described below and the controller 400. In addition, there is power supply wiring for supplying power from a battery to each of the meter panel 100, the controller 400, the ECU group 610, and the sensors 620 of the work vehicle.

One example of the controller 400 in the present example embodiment is a computing device including at least one processor and at least one memory that stores a computer program (code) defining a control process to be executed by the processor. Another example of the controller 400 is a computing device including a hardware accelerator such as an FPGA (Field-Programmable Gate Array), ASSP (Application Specific Standard Product), or ASIC (Application-Specific Integrated Circuit) configured to execute the control process.

A “processor” in the present example embodiment is a hardware electronic circuit such as a CPU (Central Processing Unit), GPU (Graphics Processing Unit), DSP (Digital Signal Processor), ISP (Image Signal Processor), or NPU (Neural Network Processing Unit). A “memory” is a hardware electronic circuit such as a ROM (Read Only Memory) or RAM (Random Access Memory). A portion of the memory may be a storage medium connected to the processor by wiring or a network. These hardware electronic circuits may be implemented by one or more integrated circuits (IC) or large-scale integrated circuits (LSI). Each functional unit or block in an electronic circuit and related components may be individually manufactured as separate integrated circuit chips, or some or all of these functional units or blocks may be combined and manufactured as a single integrated circuit chip.

A program that defines the operation of the processor is designed so that the processor executes one or more functions, operations, steps, or processes in the example embodiments of the present invention.

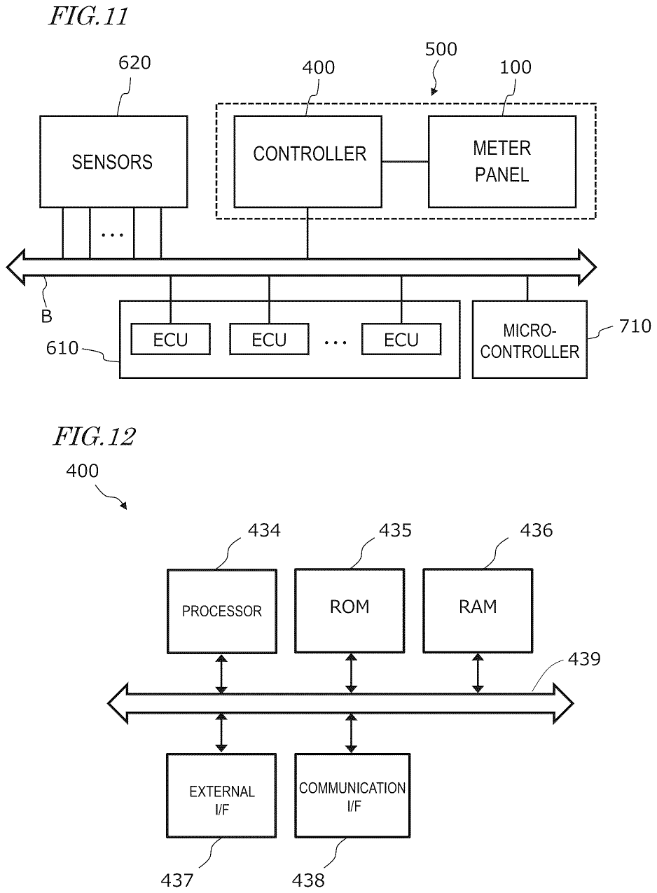

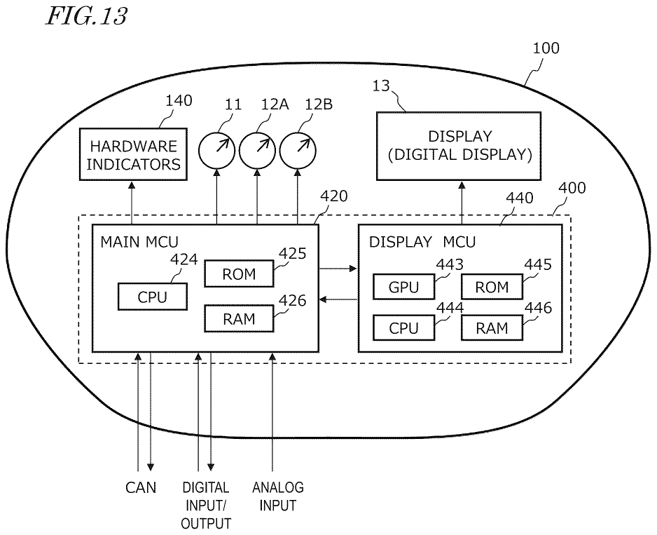

FIG. 12 is a block diagram illustrating an example hardware configuration of the controller 400. The controller 400 includes a processor 434, a ROM 435, a RAM 436, an external I/F 437, and a communication I/F 438. These components are interconnected via a bus 439.

The ROM 435 is, for example, a writable memory (e.g., PROM), a rewritable memory (e.g., flash memory), or a read-only memory. The ROM 435 stores programs that control the operation of the processor. The ROM 435 does not need to be a single recording medium and may be a collection of multiple recording media. A portion of the multiple collections may be removable memory.

The RAM 436 provides a working area for temporarily expanding programs stored in the ROM 435 at boot time. The RAM 436 does not need to be a single recording medium and may be a collection of multiple recording media.

The external I/F 437 is an interface to connect the meter panel 100 to external devices. Examples of the external I/F 437 include a universal serial bus (USB) interface and digital or analog video interfaces.

The communication I/F 438 is an interface to perform communication between the controller 400 and other electronic components or ECUs. For example, the communication I/F 438 can perform wired communication in accordance with various protocols such as CAN or Ethernet®. The communication I/F 438 may perform wireless communication in accordance with Bluetooth® standards and/or Wi-Fi® standards. Both standards include wireless communication standards using frequencies in the 2.4 GHz band.

The controller 400 may further include a storage device. The storage device may be, for example, a semiconductor memory, a magnetic storage device, or an optical storage device, or a combination thereof.

The ECU group 610 included in the work vehicle includes, for example, an ECU for speed control, an ECU configured or programmed to perform steering control, and an ECU configured or programmed to perform implement control. When the work vehicle (e.g., tractor) is configured to travel by automatic driving, the ECU group 610 may further include an ECU configured or programmed to perform automatic driving control. The ECU configured or programmed to perform automatic driving control performs calculations and control for realizing automatic driving based on data output from various sensors mounted on the vehicle body.

The sensors 620 may include, for example, a temperature sensor, an illuminance sensor, a fuel sensor, a water temperature sensor, an oil level gauge, an engine rotation sensor, a vehicle speed sensor, a battery voltage sensor, a shuttle sensor, a hand accelerator sensor, an accelerator pedal sensor, a main transmission lever sensor, a sub-transmission lever sensor, a seat belt sensor, a PM sensor, an acceleration sensor, an angular velocity sensor, an inertial measurement unit (IMU), a geomagnetic sensor, an imaging device, a LiDAR sensor, an ultrasonic sensor, an obstacle contact sensor, and a global navigation satellite system (GNSS) receiver.

The controller 400 of the information display system 500 may be an integrated circuit device mounted on a substrate inside the meter panel 100, or may be an external integrated circuit device externally attached to the meter panel 100. Furthermore, some or all of the functions of the controller 400 may be realized by one or more vehicle ECUs. Alternatively, some or all of the functions of the controller 400 may be realized by one or more servers (computers) connected via the communication I/F 438 through a communication network. In this way, one or more vehicle ECUs and/or one or more servers may cooperate with the controller 400 to realize various functions required for the information display system 500. In this case, the vehicle ECU and/or the server function as part of the information display system 500.

FIG. 13 is a block diagram illustrating an example in which the controller 400 is implemented inside the meter panel 100. In this example, the controller 400 includes two microcontroller units (MCUs). The two MCUs are a main MCU 420 and a display MCU 440. The main MCU 420 is a controller that is configured or programmed to control the overall operation of the meter panel 100. The main MCU 420 may also be referred to as a “main controller.” The display MCU 440 is a controller that is configured or programmed to control rendering on the display 13 (i.e., digital display) such as an LCD. The display MCU 440 may also be referred to as a “display controller” or “LCD MCU.”

The main MCU 420 includes components such as a CPU 424, a ROM 425, and a RAM 426, for example. The main MCU 420 controls hardware indicators 140, the first analog meter 11, the second analog meter 12 (in this example embodiment, two analog meters 12A and 12B), and the display MCU 440. The hardware indicators 140 includes the arc-shaped indicator 40 and a plurality of light emitting devices such as LEDs behind the indicator regions 14T, 14L, and 14R illustrated in FIG. 5. The ROM 425 is a non-volatile memory that stores software (programs and various data used in processing) to be executed by the CPU 424. The main MCU 420 controls the overall operation of the meter panel 100 by the CPU 424 executing the software. The main MCU 420 may include an interface to communicate with one or more vehicle ECUs connected to the meter panel 100 via an in-vehicle network such as CAN. The main MCU 420 may also include an external interface that enables input and output of digital signals to and from devices directly connected to the meter panel 100. The main MCU 420 may further include an analog interface to which analog signals such as the voltage of the external battery are input.

The display MCU 440 includes components such as a CPU 444, a GPU 443, a ROM 445, and a RAM 446, for example. The ROM 445 is a non-volatile memory that stores software to be executed by the CPU 444 and the GPU 443. The display MCU 440 controls rendering on the display 13 (i.e., digital display) by the CPU 444 and GPU 443 executing the software.

In the example illustrated in FIG. 13, the display MCU 440 dedicated to image processing is provided separately from the main MCU 420. This is to achieve relatively high-load rendering such as color camera images and 3D display on the display 13 such as a relatively large (e.g., 10 inches or more) and high-definition LCD. Unlike the present example embodiment, if the display 13 is small or a monochrome liquid crystal display and sophisticated image processing is not required, the display MCU 440 may not be provided, and one controller (i.e., the main MCU 420) may perform all control including rendering.

In the information display system 500 of this example embodiment, the controller 400 is configured or programmed to cause the arc-shaped indicator 40 to display information before causing the display 13 to display various kinds of information when the work vehicle is started. This allows information that the operator should first be aware of to be presented to the operator with higher priority at startup. Such information has information indicating a state (a state classified as abnormality in traveling or working) of the work vehicle. The controller 400 is also configured to change the color of emitted light according to contents of information. For example, the controller 400 may be configured or programmed to emit blue light from the arc-shaped indicator 40 when an abnormality does not arise during starting, and to emit red light indicating an abnormality immediately after starting if a problem is expected to arise during traveling. Examples of a cause for a problem that will arise during traveling include an abnormal voltage of a battery, an abnormal pressure of an engine oil, abnormal heating of an engine, and an abnormality in a brake system. It should be noted that the color of the emitted light is not limited to blue or red, and may be green.

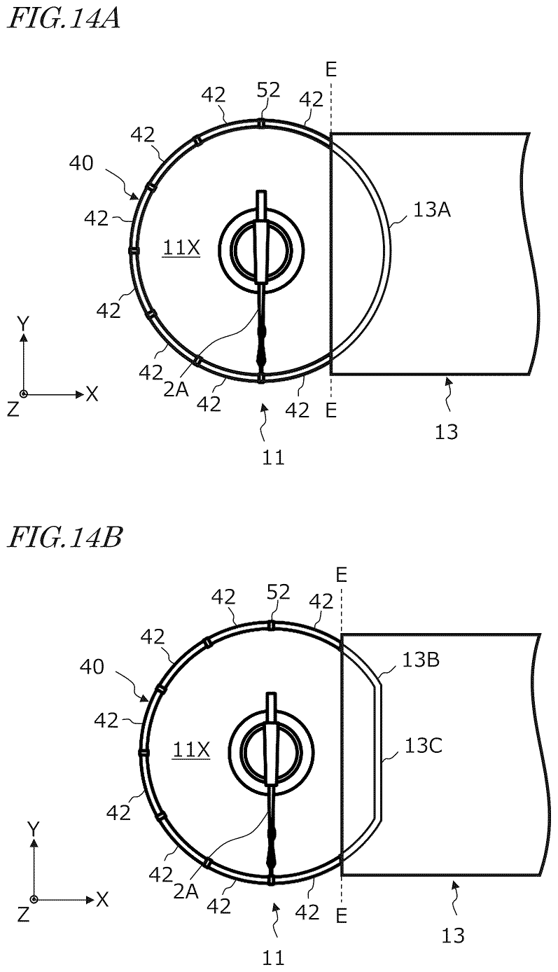

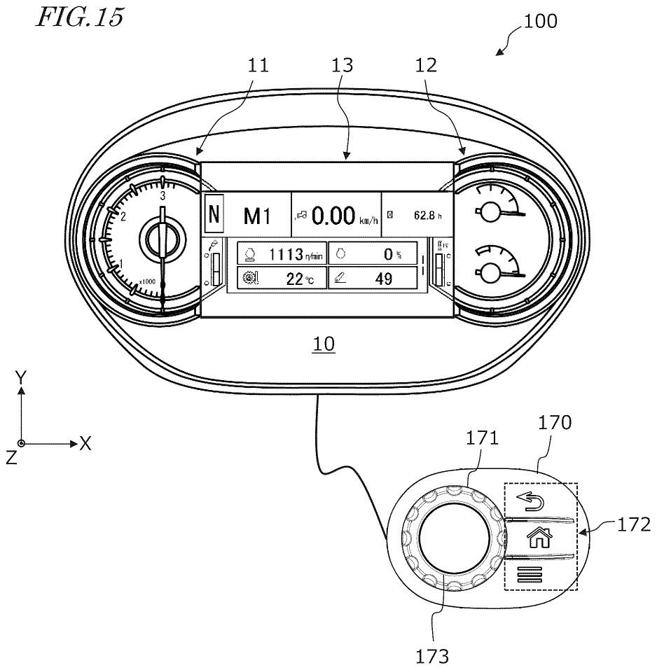

Furthermore, in this example embodiment, the controller 400 is configured or programmed to cause the display 13 to display a curved line-shaped image positioned on an extension of the arc. FIG. 14A is a front view schematically illustrating an example in which an arc 13A having the same color as that of light emitted from the light emitting region 42 of the arc-shaped indicator 40 is displayed. In FIG. 14A, as an example, an arc 13A having the same center as that of the arc of the arc-shaped indicator 40 is displayed. FIG. 14B is a front view schematically illustrating an example in which an arc 13B having the same color as that of light emitted from the light emitting region 42 of the arc-shaped indicator 40, and another object 13C having an arc with the same color, are displayed. In the example of FIG. 14B, the object 13C is a straight line portion. The controller 400 causes the display 13 to display the concentric arc 13B with the arc of the light emitting region 42, and the straight line portion connected to the arc 13B. The straight line portion extends in parallel with a straight line forming the boundary between the first analog meter 11 and the display 13 (corresponding to a dashed line E-E of FIG. 14B). By providing such display, a portion of the circle surrounding the first analog meter 11 that is cut away by the dashed line E-E is seen as a portion of the first analog meter 11 by the operator, and therefore, the operator can feel that the first analog meter 11 is large. In addition, an image that is displayed as if the image were a portion of the first analog meter 11 (hereinafter referred to as a “ring-complement image”) may be partially hidden by information such as numerals or letters displayed on the display 13. Similarly to the shaped object 13C, the portion of the arc 13B may include a straight line shape. By including a straight line shape in the portion displayed on the display 13, a sharp design can be achieved.

The controller 400 can be configured or programmed to cause the display 13 to display various images, which are not limited to the examples of FIGS. 14A and 14B, in association with light emitted from the light emitting region 42 of the arc-shaped indicator 40. The controller 400 can also be configured or programmed to cause the display 13 to display various images in synchronization with the flickering of the light emitting region 42 of the arc-shaped indicator 40. What is conveyed by the display of the arc-shaped indicator 40 to notify the operator can be more easily understood by the operator by emphasizing that display and the display of the display 13 or associating these displays with each other.

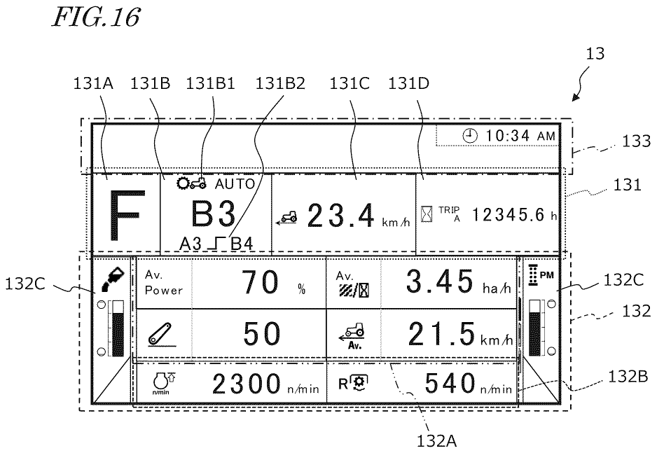

After startup of the meter panel 100, a home screen is displayed in the display region of the display 13. FIG. 15 is a diagram illustrating an example of a home screen. Starting from the home screen, the user can perform operations to change the display of content on the display region or select various setting items using an input device described below.

In the example illustrated in FIG. 15, an input device 170 that enables interactive operations by the user is connected to the meter panel 100 via a communication cable. The input device 170 has, for example, a selector switch 171 such as a jog dial and an operation switch 172. The input device 170 may be connected to the meter panel 100 wirelessly or by wire. Any device that accepts user operations can be used as the input device 170. The input device 170 may be, for example, a rotary switch, a slide switch, a push button switch, a touch screen, a joystick, or a combination of two or more thereof.

The display 13 includes a display region in which various images showing information about the work vehicle are displayed. Information about the work vehicle includes, for example, information related to an internal combustion engine (engine), the vehicle body, a PTO shaft, hydraulics/three-point hitch, and electrical equipment provided in the vehicle body. This information is information indicating the internal state of the vehicle system. Information related to the vehicle body includes, for example, information about the direction of travel of the vehicle, clutch, transmission, brakes, headland control, and cruise control. Furthermore, various content including, for example, camera images, radio setting screens, and audio setting screens may be displayed in the display region of the display 13.

Next, segmentation of the display region will be described with reference to FIG. 16. FIG. 16 is a diagram schematically illustrating an example of segmentation of the display region. The display region of the display 13 is divided into multiple blocks. In other words, the display region of the display 13 has multiple regions. The multiple regions in the example illustrated in FIG. 16 include a primary region 131, a sub-region 132, and an LCD indicator region 133. The primary region 131 in FIG. 16 is a region surrounded by a dotted line in the display region of the display 13. The sub-region 132 is a region surrounded by a dashed line in the display region of the display 13. The LCD indicator region 133 is a region surrounded by a dash-dot line in the display region of the display 13. These three regions do not overlap with each other. It should be noted that the dashed lines, dotted lines, and dash-dot lines in FIG. 16 are partially overlapping for clarity.

The primary region 131 is a region to display images in the foreground (or front). The primary region 131 in the example illustrated in FIG. 16 is a rectangular region (or panel-shaped region). However, the external shape of the primary region 131 may be, for example, an ellipse or a figure that is a combination of straight lines and curved lines. A primary image showing more important information (hereinafter referred to as “primary information”) among information about the work vehicle is displayed in the primary region 131. The primary information is information that the user should know with priority, and includes, for example, information indicating the direction of travel of the work vehicle, transmission state, and vehicle speed (hereinafter referred to as “vehicle speed”).

The primary information indicated by the primary image displayed in the primary region 131 in this way is displayed in the foreground of the display region. As illustrated in FIG. 15, the primary image is displayed in front of the ring-complement image. In this way, the primary image can appropriately convey primary information to the user without being hidden by other images or content. Therefore, the visibility of primary information with particularly high importance among various information is improved, and overlooking of primary information is reduced.

In the example illustrated in FIG. 16, the primary region 131 has a belt-shaped configuration extending in the horizontal direction. Multiple types of information about the travel state of the work vehicle are displayed in the primary region 131. The primary region 131 is divided into multiple regions. In the example of FIG. 16, the primary region 131 is divided into a first region 131A, a second region 131B, a third region 131C, and a fourth region 131D arranged horizontally.

The first region 131A positioned at the left end displays the state of the shuttle lever of the work vehicle, that is, the direction of travel. The first region 131A displays, for example, information indicating whether the shuttle lever is in a forward (F), neutral (N), or reverse (R) state.

The second region 131B positioned second from the left displays information about the transmission state, for example, setting of the gear stage of the work vehicle. In the example of FIG. 16, the current settings of the main transmission and sub-transmission are displayed as “B3” symbols in the second region 131B. “B” indicates the setting stage of the sub-transmission, and “3” indicates the setting stage of the main transmission. The second region 131B may display an icon 131B1 indicating that it is in automatic transmission mode and a range 131B2 of gear stages in the automatic transmission mode, as illustrated in FIG. 16.

The third region 131C displays vehicle speed information. The controller 400 switches and displays vehicle speed information in kilometer units or mile units according to, for example, commands from the vehicle ECU.

The fourth region 131D at the right end displays information other than the direction of travel, transmission state, and vehicle speed. In the example of FIG. 16, the fourth region 131D displays the measured value of the hour meter, that is, the operating time of the work vehicle up to now. The fourth region 131D may display other information, not limited to the measured value of the hour meter. For example, various information such as the upper limit setting value of engine speed or the target value of engine speed recorded in memory may be displayed in the fourth region 131D. The controller 400 may be configured or programmed to dynamically change the display of the fourth region 131D according to, for example, commands from the vehicle ECU. The fourth region 131D, together with a region 132B described below, dynamically displays the performance of travel and work of the work vehicle. Therefore, the fourth region 131D is sometimes referred to as a “dynamic performance monitor region.”

The sub-region 132 is positioned below the primary region 131. Various content is displayed in the sub-region 132. The sub-region 132 in the example illustrated in FIG. 16 is a rectangular region and is further divided into three types of regions. The sub-region 132 includes a performance monitor region 132A, a dynamic performance monitor region 132B, and two gauge regions 132C.

The performance monitor region 132A is the largest region among the three regions included in the sub-region 132 and is positioned toward the upper side of the sub-region 132. The performance monitor region 132A is sometimes referred to as the “upper region” in the sub-region 132. The performance monitor region 132A mainly displays one or more items selected by the user (hereinafter referred to as “selected items”) from among various items showing various functional performance information. Examples of items that can be selected by the user include information about engine speed, engine speed upper limit setting value, engine speed memory value, fuel consumption, fuel efficiency, travel distance, load factor, PTO shaft rotation speed, slip rate, diesel particulate filter (DPF) regeneration, and work area.

The screen of selected items may include multiple pages that can be advanced or returned by the user operating the input device. FIG. 16 shows an example of multiple selected items displayed on one page among multiple pages. In the example illustrated in FIG. 16, four selected items are displayed on one page. However, the number of selected items displayed on one page is not limited to four and may be, for example, two, three, or five or more.

The dynamic performance monitor region 132B is positioned toward the lower side of the sub-region 132. The dynamic performance monitor region 132B is sometimes referred to as the “lower region” in the sub-region 132. Various items showing the various functional performance information described above may be displayed in the dynamic performance monitor region 132B. The display of information displayed in the dynamic performance monitor region 132B may be controlled by the controller 400 (e.g., meter ECU) that receives commands from, for example, the vehicle ECU. The controller 400 may be configured or programmed to change the display of the dynamic performance monitor region 132B in response to commands from the vehicle ECU. As illustrated in FIG. 16, for example, two items may be displayed in the dynamic performance monitor region 132B. However, the number of items is not limited to two. Nothing may be displayed in the dynamic performance monitor region 132B as illustrated in FIG. 15.

The gauge regions 132C are positioned on the right and left sides of the sub-region 132. The performance monitor region 132A and the dynamic performance monitor region 132B are positioned between the two gauge regions 132C on the right and left. Gauge images including icons and scales may be displayed in each of the gauge regions 132C on the right and left sides. Examples of gauge images include information about the remaining amount of diesel exhaust fluid (DEF), particulate matter (PM) accumulation, and tire air pressure.

The images displayed in the performance monitor region 132A and the dynamic performance monitor region 132B may be changed according to user operations using the input device. For example, camera images, images for radio or audio settings, images for front loader control, images for cylinder flow control, images to set operators, images for steering assist control, images for automatic steering control, images for attachment work machine control, or launcher images displaying a list of functional items may be displayed in a region corresponding to the entire performance monitor region 132A and dynamic performance monitor region 132B. By integrating two or more regions and using them as one region in this way, images and content can be displayed relatively large.

The LCD indicator region 133 is positioned above the primary region 131. The LCD indicator region 133 in the example illustrated in FIG. 16 is a rectangular region like the primary region 131 and the sub-region 132. The LCD indicator region 133 functions as a region to display information indicating the state of the work vehicle, warning information, maintenance-related information, and the like. For example, indicators that turn on when a warning state such as brake warning or fuel remaining warning should be issued and turn off when the state is resolved may be displayed in the LCD indicator region 133. As another example, indicators that turn on periodically to prompt the user for maintenance such as DPF regeneration or engine oil change may be displayed in the LCD indicator region 133. As a further example, indicators to request an increase or decrease in engine speed may be displayed in the LCD indicator region 133. In the LCD indicator region 133, no indicators are normally displayed, and a black background is displayed. When a state requiring display of warning or maintenance information arises, the indicator corresponding to that warning or maintenance information turns on. A maximum of, for example, about 10 indicators may be displayed in the LCD indicator region 133. Since indicators can be displayed prominently against a black background, it is possible to make it easier for the operator or user to notice the occurrence of LCD indicators.

The LCD indicator region 133 is positioned below the indicator region 14T illustrated in FIG. 5. The indicators arranged in the indicator region 14T are hardware indicators that are turned on by light emitting devices such as LEDs. In contrast, the indicators displayed in the LCD indicator region 133 are turned on by drawing processing on the LCD. In this specification, hardware indicators using LEDs are referred to as “LED indicators,” and indicators displayed in the LCD indicator region 133 are referred to as “LCD indicators,” and the two may be distinguished.

A popup image including a message for notifying the user of the content of an abnormality or failure when, for example, an abnormality or failure of the engine or electrical equipment is detected, or a message for warning about the internal state of the vehicle system (hereinafter sometimes referred to as a “popup image”) may also be displayed in the sub-region 132 illustrated in FIG. 16. In addition, popup images including messages indicating maintenance information may also be displayed in the sub-region 132.

As illustrated in FIG. 15, the meter panel 100 is connected, wirelessly or by wire, to an input device 170 that enables interactive operations by the user. The user can change setting values of a device (e.g., a driver) included in the work vehicle by operating a selector switch 171 included in the input device 170.

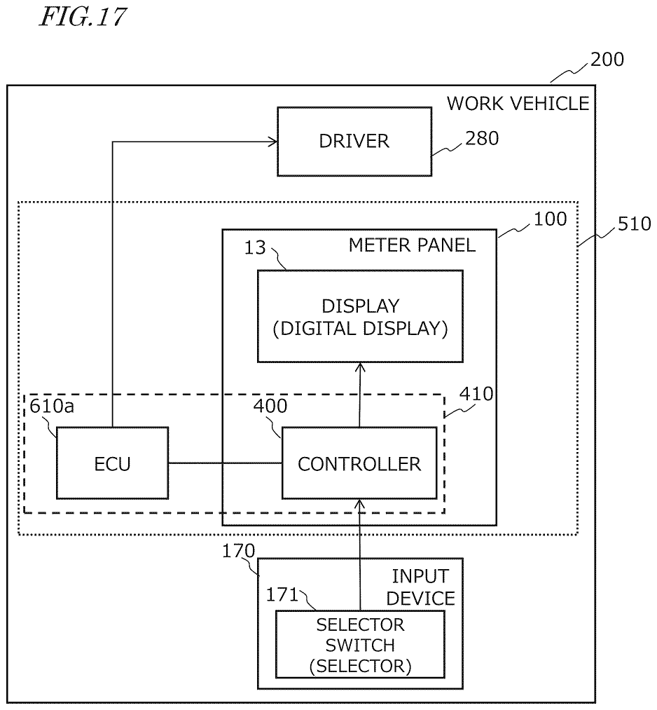

An example of the control system of the present example embodiment will be described with reference to FIG. 17. FIG. 17 is a block diagram schematically illustrating a part of a configuration of a work vehicle 200 having the control system 510 of the present example embodiment. As illustrated in the example of FIG. 17, the control system 510 of the present example embodiment includes a controller 410 that controls a driver 280 (which may also be referred to as a “predetermined device”) included in the work vehicle 200, and a meter panel 100 including a display 13 (which may also be referred to as a “digital display”). The controller 410 causes the display 13 to display a setting value of the driver 280. The controller 410, when a user performs an operation of a selector switch 171 (which may also be referred to as a “selector”) to change the setting value, detects a speed at which the selector switch 171 moves by the user's operation, and changes an amount of change in the setting value per predetermined displacement amount of the selector switch 171 according to the detected speed.

The driver 280 includes, for example, various devices necessary for travel and operation of the work vehicle 200, such as a prime mover (engine) 202, a transmission 203, and a travel device of the work vehicle 200. The driver 280 includes, for example, an engine controller capable of changing the rotation speed of the engine 202, a transmission controller capable of changing the gear stage setting and/or sensitivity of the transmission 203, and the like. The control system 510 may be applied to one or more devices included in the driver 280.

The controller 410 is configured or programmed to include the controller 400 in the meter panel 100 and an ECU 610a in a vehicle body 201 of the work vehicle 200. The ECU 610a is an ECU included in the vehicle ECU group 610 (see FIG. 11) inside the vehicle body 201 of the work vehicle 200. The ECU 610a may include a combination of two or more ECUs among the ECUs included in the vehicle ECU group 610. As illustrated in FIG. 11, the controller 400 and the vehicle ECU group 610 (including the ECU 610a) in the vehicle body 201 are communicably connected to each other via a bus B. The ECU 610a is configured or programmed to control travel and operation of the work vehicle 200 by transmitting and receiving signals to and from devices included in the driver 280.

As will be described later, the control system according to example embodiments of the present disclosure is not limited to a specific device of the driver 280, and may be applied to various devices included in the work vehicle 200 depending on the state of the work vehicle 200 and the operations of the user. The control system of the present example embodiment is not limited to the work vehicle 200 and may be applied to work vehicles according to other example embodiments. The control system of the present example embodiment may be used, for example, in the information display system 500 (see FIG. 11). Some or all of the processing performed by the controller 410 of the control system 510 may be performed by another ECU 610 included in the vehicle ECU group 610 (see FIG. 11) disposed in the vehicle body 201 of the work vehicle 200. Some or all of the processing performed by the controller 410 of the control system 510 may be performed by either the controller 400 or the ECU 610a.

According to the control system 510, when the user operates the selector switch 171 to change a setting value of a device included in the driver 280, the amount of change in the setting value per predetermined displacement amount of the selector switch 171 (e.g., per unit displacement amount of the selector switch 171) differs depending on the speed at which the selector switch 171 moves. If the amount of change in the setting value per predetermined displacement amount of the selector switch 171 is constant, for example, the greater the amount by which the setting value is to be changed, the longer the time required for the operation to move the selector switch 171. For example, when operating a jog dial as illustrated, the user may have to continue rotating the jog dial for many turns. According to the control system 510, compared to a case in which the amount of change in the setting value per predetermined displacement amount of the selector switch 171 is constant, it is possible to improve the operability of changing setting values and to improve user convenience.

For example, when the user operates the selector switch 171 to change a setting value of a device included in the driver 280 of the work vehicle 200, it is conceivable that the user operates the selector switch 171 quickly when wishing to change the setting value greatly (substantially), and operates the selector switch 171 slowly when wishing to finely adjust the setting value. For example, the controller 410 makes the amount of change in the setting value per the predetermined displacement amount of the selector switch 171 larger when the detected speed is a first speed than when the detected speed is a second speed that is smaller than the first speed. In this case, the user can change the setting value quickly and easily. Since the user can reach a desired setting value more quickly, user convenience is improved. According to the control system 510, the operability of changing setting values is improved and the burden on the user (including effort, cost, and time) required for changing setting values is reduced, so that user convenience can be improved. Here, an example of the selector switch 171 that is a rotary selector is shown, but the selector switch 171 is not limited to a rotary selector and may be other types of selectors. Similar effects may be obtained with other types of selectors.

For the selector switch 171 that is a rotary selector (a jog dial in the illustrated example), the user performs an operation to rotate the rotary selector 171, and the controller 410 detects the angular velocity of the rotary selector 171. The controller 410 includes, for example, a rotary encoder (e.g., a pulse encoder) that detects the angular velocity of the rotary selector 171. The controller 410 changes the amount of change in the setting value per rotation of the rotary selector 171 by a predetermined angle according to the detected angular velocity. For example, the controller 410 increases the amount of change in the setting value per unit amount of the rotation angle of the rotary selector 171 as the detected angular velocity increases.

FIG. 18 is a diagram schematically illustrating an example of display on the display 13 of the meter panel 100. In the example illustrated in FIG. 18, three images (or graphs) 136a to 136c described below are simultaneously displayed on a single screen in the display region of the display 13. The user can select an image displaying the setting value to be changed from among the three images by operating the rotary selector 171 and/or the push-button switch 173 described below, and can change the respective setting values as described below using the selected image.

In the example of FIG. 18, a graph 136b (which may also be referred to as a “first graph”) with a value that increases or decreases along a circumference or an arc is displayed in the sub-region 132 of the display region of the display 13. The controller 410 changes the display content of the graph 136b according to a change in the setting value. In this example, the graph 136b displays a set speed in cruise control. The user can change the set speed in cruise control by operating the rotary selector 171. The user can increase the set speed by rotating the rotary selector 171 to the right, and can decrease the set speed by rotating the rotary selector 171 to the left. The user can operate the rotary selector 171 while immediately confirming the change in the set speed by the display on the display 13. Displaying the change in the set speed using the graph 136b with a value that increases or decreases along a circumference or an arc makes it easy for the user to understand that the display corresponds to the rotary selector 171, thereby improving operability.

In the example illustrated in FIG. 15, the rotary selector 171 includes a push-button switch 173. The push-button switch 173 is circular in shape and is combined with the rotary selector 171. As illustrated in the example of FIG. 18, the controller 410 causes the display 13 to display a switch image 136a corresponding to the push-button switch 173, and changes the display content of the switch image 136a according to an operation of the push-button switch 173 by the user. For example, the user can switch cruise control settings on and off by pressing the push-button switch 173. The switch image 136a being an image that represents (imitates) the shape of the push-button switch 173, for example, being an image having a circular figure in the example of FIG. 18, makes it easy for the user to understand that the display corresponds to the push-button switch 173, thereby improving operability.

In the example illustrated in FIG. 18, an image 136c is further displayed on the display 13. As in the example of the image 136c, the controller 410 causes the display 13 to display two options (“Current speed” and “Memory”) to set a mode (a mode related to cruise control), and changes a candidate option to be selected from among the two options according to an operation of the user to rotate the rotary selector 171. The user can select either mode from the two modes by operating the rotary selector 171. In the image 136c, the position of a cursor indicating the mode to be selected moves along a circumference or an arc. The image 136c makes it easy for the user to understand that it is a display corresponding to the rotary selector 171, thereby improving operability.

In the example of FIG. 18, a popup image 136 including these three images 136a to 136c is displayed together with an icon image 136q for the user to perform an operation to hide the popup image 136. The operation by the user to hide the popup image 136 (a dismissal operation) is performed, for example, by the user selecting the icon image 136q. For example, while the popup image 136 is displayed, the above settings related to cruise control can be made.

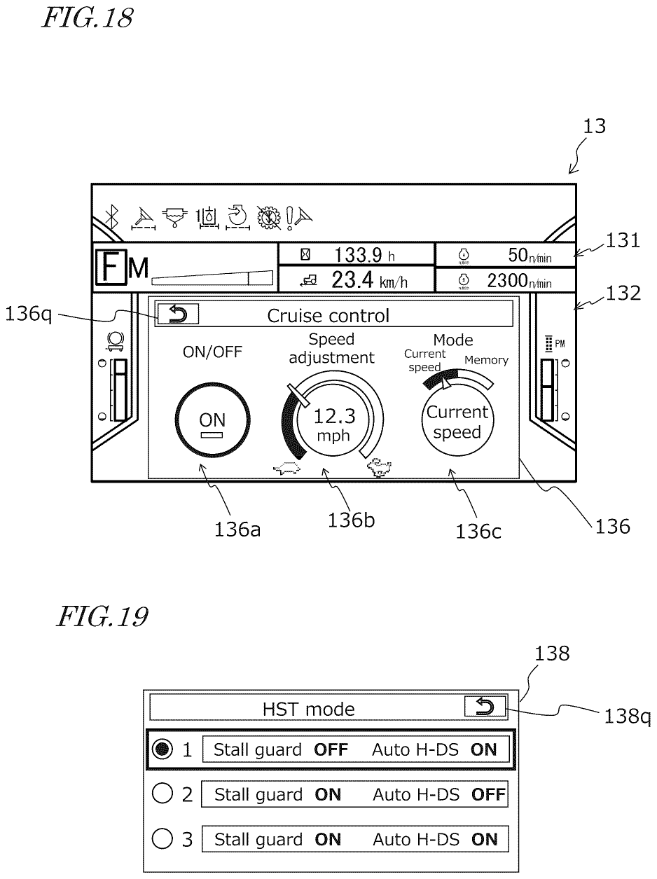

Another example of displaying a plurality of options will be described with reference to FIG. 19. FIG. 19 illustrates another example of display on the display 13. Instead of the popup image 136 of FIG. 18, the popup image 138 of FIG. 19 may be displayed, for example, in the sub-region 132 of the display 13.

The image 138 of FIG. 19 displays three options (“1”, “2”, and “3”) to set an HST mode. The three options differ in the content set in the work vehicle 200. The three options are arranged vertically in the image 138. In the example of FIG. 19, the controller 410 changes a candidate option to be selected from among the three options according to an operation of the user to rotate the rotary selector 171. In the image 138 of FIG. 19, setting content information indicating the content to be set in the work vehicle 200 is displayed for each of the three options (“1”, “2”, and “3”) together with the respective options. In the example of FIG. 19, each piece of setting content information is displayed so as to be adjacent to the corresponding option. As in the example of FIG. 19, by having the setting content information indicating the content to be set in the work vehicle 200 for each of the plurality of options displayed together with each of the plurality of options on a single screen, the user does not need to refer to another screen to confirm the content of each option, thereby reducing the burden on the user (including effort, cost, and time) in making settings. As in the example of FIG. 19, by having each piece of setting content information displayed so as to be adjacent to the corresponding option, a display that is particularly easy for the user to see can be provided, which can lead to improved operability.

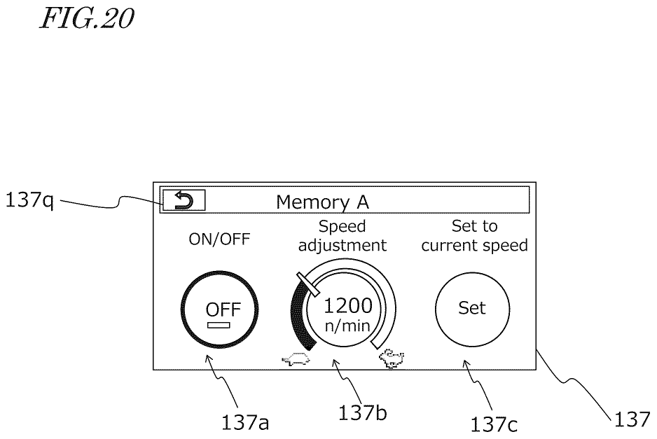

FIG. 20 illustrates another example of display on the display 13. Instead of the popup image 136 of FIG. 18, the popup image 137 of FIG. 20 may be displayed, for example, in the sub-region 132 of the display 13. Description of items common to the example of FIG. 18 may be omitted.

The image 137 of FIG. 20 includes an image (graph) 137b to set an engine rotation speed. The controller 410 causes the display 13 to display the value of the engine rotation speed, and changes the engine rotation speed according to an operation of the user to rotate the rotary selector 171. The user can increase the setting value by rotating the rotary selector 171 to the right, and can decrease the setting value by rotating the rotary selector 171 to the left. The user can immediately confirm the change in the setting value by the display on the display 13. Using the graph 137b with a value that increases or decreases along a circumference or an arc makes it easy for the user to understand that the display corresponds to the rotary selector 171, thereby improving operability.

The image 137 of FIG. 20 further includes images 137a and 137c corresponding to the push-button switch 173, and an icon image 137q for the user to perform an operation to hide the popup image 137. The user can change the on/off state of the settings using the images 137a and 137c respectively.

The display on the display 13 is not limited to the examples illustrated, and the control system 510 may be used to set various devices. For example, the controller 410 may cause the display 13 to display an image to set the gear stage setting and/or sensitivity of the transmission. The controller 410 may cause the display 13 to display the setting value of the gear stage setting and/or sensitivity of the transmission, and may change the gear stage setting and/or sensitivity of the transmission according to an operation of the user to rotate the rotary selector 171.

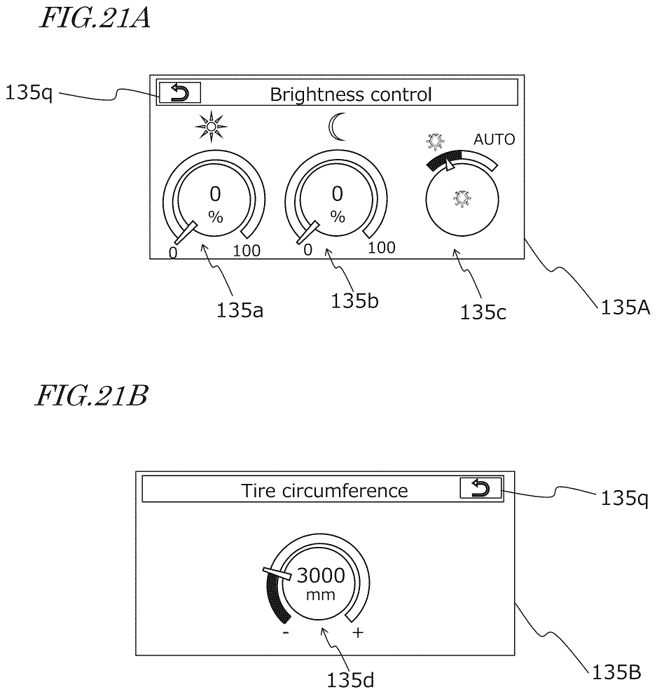

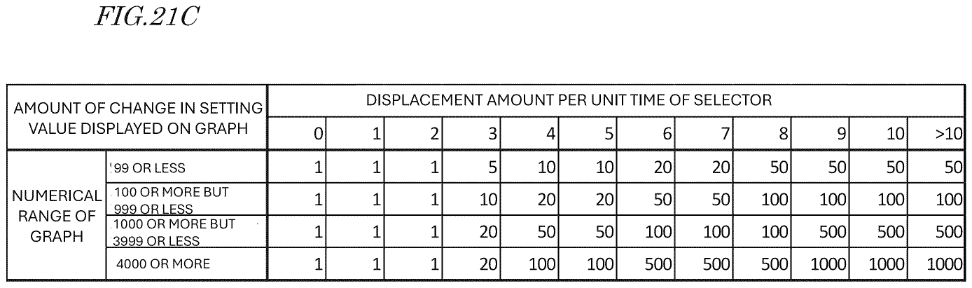

Another example of operation of the control system 510 will be described with reference to FIGS. 21A, 21B, and 21C. FIGS. 21A and 21B illustrate examples of display on the display 13 in the control system 510, and FIG. 21C illustrates an example of a lookup table referenced by the controller 410.

When the control system 510 is applied to a plurality of devices included in the driver 280, the amount of change in the setting value per predetermined displacement amount of the selector switch 171 may be changed depending on the device (i.e., depending on the setting item). That is, when applied to a first device and a second device included in the driver 280, the controller 410 makes the amount of change in the setting value per the predetermined displacement amount of the selector switch 171 for the same speed at which the selector switch 171 moves different between a case in which the setting value of the first device is changed and a case in which the setting value of the second device is changed. If the amount of change in the setting value per predetermined displacement amount of the selector switch 171 is constant for the setting items of the applied device, the user may find it inconvenient to change the setting value. By making the amount of change in the setting value per predetermined displacement amount of the selector switch 171 different depending on the setting item of the applied device, user convenience is improved.

For example, the graph 137b with a value that increases or decreases along a circumference or an arc, included in the image 137 illustrated in FIG. 20, is a graph displaying the engine rotation speed and corresponds to a numerical range from 0 [n/min] to 3000 [n/min]. On the other hand, graphs 135a and 135b with a value that increases or decreases along a circumference or an arc, included in the image 135A illustrated in FIG. 21A, are graphs displaying the brightness of the display 13 and correspond to a numerical range from 0 [%] to 100 [%]. In addition, a graph 135d with a value that increases or decreases along a circumference or an arc, included in the image 135B illustrated in FIG. 21B, is a graph displaying the tire circumference of the wheel 204 and corresponds to a numerical range from 0 [mm] to 9999 [mm]. As described above, the numerical range displayed as a graph on the display 13 may differ greatly depending on the setting item. In all cases, if the amount of change in the setting value per predetermined displacement amount of the selector switch 171 is constant, the user may find it inconvenient when changing the setting value. Making the amount of change in the setting value per predetermined displacement amount of the selector switch 171 different may improve user convenience. For example, the lookup table illustrated in FIG. 21C makes the amount of change in the setting value displayed on the graph for a displacement amount per unit time of the selector switch 171 different depending on the size of the numerical range displayed as a graph on the display 13 (i.e., the difference between the minimum and maximum values that can be displayed on the graph). According to the lookup table of FIG. 21C, the graph 137b displaying the engine rotation speed of FIG. 20, the graphs 135a and 135b displaying the brightness of the display 13 of FIG. 21A, and the graph 135d displaying the tire circumference of the wheel 204 of FIG. 21B differ from each other in the amount of change in the setting value displayed on the graph for a displacement amount per unit time of the selector switch 171, so that user convenience is improved. Note that in the case of a display with a small number of options (i.e., a small numerical range), such as the image 138 of FIG. 19, the lookup table of FIG. 21C need not be applied.

A lookup table such as the example of FIG. 21C is stored, for example, in a storage device of the controller 400. A lookup table such as the example of FIG. 21C is not limited to graphs with a value that increases or decreases along a circumference or an arc, and may be applied also when, for example, a bar graph or a bar chart is displayed on the display 13.

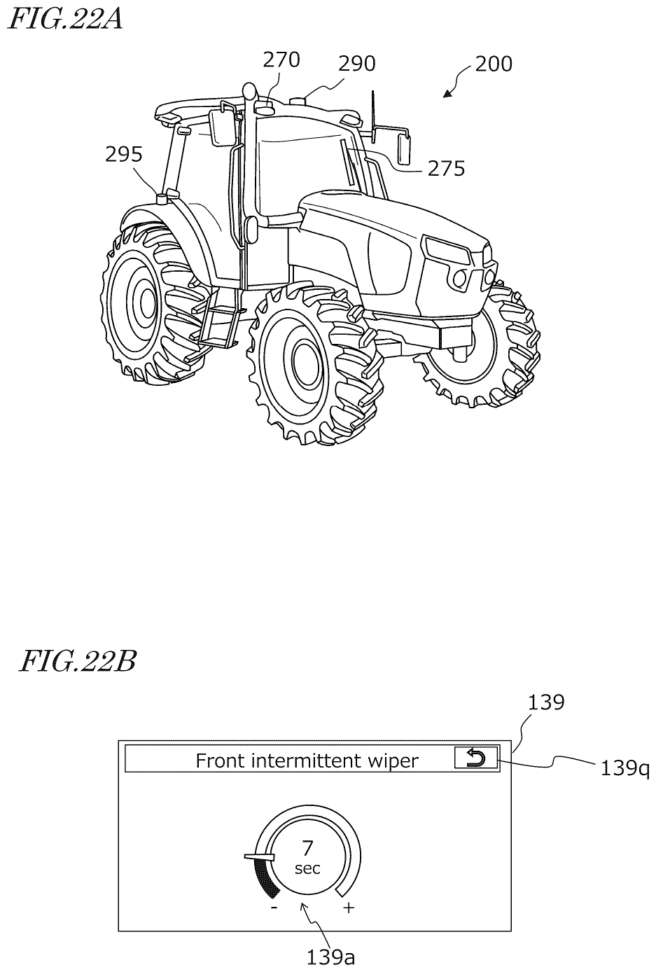

Another application example of the control system 510 will be described with reference to FIGS. 22A and 22B. FIG. 22A is a perspective view illustrating an example of an external appearance of the work vehicle 200. FIG. 22B is an example of display on the display 13 in the control system 510.

The control system 510 is also applied to a wiper driver, included in the driver 280, that operates a wiper 275 of the work vehicle 200. The ECU 610a is configured or programmed to control the operation of the wiper 275 by transmitting a signal to the wiper driver and controlling the wiper driver. For example, the wiper driver is capable of changing the length of a time that is the time during which the wiper is stationary between one operation of the wiper 275 and the next operation thereof (which may also be referred to as a “stationary time”).

As illustrated in FIG. 22B, the controller 410 is configured or programmed to cause the display 13 to display an image 139a to set the stationary time of the wiper. The controller 410 is configured or programmed to cause the display 13 to display the length of the stationary time of the wiper, and changes the length of the stationary time according to an operation of the user to rotate the rotary selector 171. The user can increase the length of the stationary time by rotating the rotary selector 171 to the right, and can decrease the length of the stationary time by rotating the rotary selector 171 to the left. In the example of FIG. 22B, a graph 139a (which may also be referred to as a “second graph”) with a value that increases or decreases along a circumference or an arc is displayed. The controller 410 changes the display content of the graph 139a according to a change in the setting value (here, the length of the stationary time). By allowing the user to change the stationary time of the wiper, the frequency of wiper operation can be adjusted in accordance with the conditions of the environment in which the work vehicle 200 travels or works, so that the load on the wiper driver (e.g., a motor) can be reduced. Furthermore, by applying the control system 510 to the wiper driver, the stationary time of the wiper can be changed without separately providing a physical switch for changing the stationary time of the wiper. In addition, by using the control system 510, as described above, the operability of changing the stationary time of the wiper can be improved and user convenience can be improved.

The information display systems and/or the control systems in the above example embodiments can also be retrofitted to work vehicles that do not have these functions. Such systems may be manufactured and sold independently of work vehicles. Computer programs used in such systems may also be manufactured and sold independently of work vehicles. Computer programs may be provided, for example, stored on non-transitory computer-readable storage media. Computer programs may also be provided by download via telecommunication lines (e.g., the Internet).

The technologies and example embodiments of the present disclosure are widely applicable to various types of work vehicles used in, for example, smart agriculture.

While example embodiments of the present invention have been described above, it is to be understood that variations and modifications will be apparent to those skilled in the art without departing from the scope and spirit of the present invention. The scope of the present invention, therefore, is to be determined solely by the following claims.

What is claimed is:

1. A control system for a work vehicle, the control system comprising:
a controller configured or programmed to control a predetermined device included in the work vehicle; and
a meter panel including a digital display; wherein
the controller is configured or programmed to cause the digital display to display a setting value of the predetermined device;
the controller is configured or programmed to, when a user performs an operation of a selector to change the setting value:
detect a speed at which the selector moves by the user's operation;, and
change an amount of change in the setting value per predetermined displacement amount of the selector according to the detected speed.

2. The control system of claim 1, wherein the controller is configured or programmed to make the amount of change in the setting value per the predetermined displacement amount of the selector larger when the detected speed is a first speed than when the detected speed is a second speed that is smaller than the first speed.

3. The control system of claim 2, wherein
the work vehicle includes a first device and a second device as the predetermined device; and
the controller is configured or programmed to make the amount of change in the setting value per the predetermined displacement amount of the selector for a same speed at which the selector moves different between a case in which the setting value of the first device is changed and a case in which the setting value of the second device is changed.

4. The control system of claim 1, wherein
the selector is a rotary selector rotatable by the user to perform an operation; and
the controller is configured or programmed to:
detect an angular velocity of the rotary selector; and
change an amount of change in the setting value per rotation of the rotary selector by a predetermined angle according to the detected angular velocity.

5. The control system of claim 4, wherein the rotary selector is a jog dial.

6. The control system of claim 4, wherein the controller is configured or programmed to:
cause the digital display to display a first graph with a value that increases or decreases along a circumference or an arc; and
change a display content of the first graph according to a change in the setting value.

7. The control system of claim 4, wherein
the rotary selector includes a push-button switch; and
the controller is configured or programmed to:
cause the digital display to display a switch image corresponding to the push-button switch; and
change a display content of the switch image according to an operation of the push-button switch by the user.

8. The control system of claim 4, wherein the controller is configured or programmed to:
cause the digital display to display a plurality of options to set a mode; and
change, according to an operation of the user to rotate the rotary selector, a candidate option to be selected among the plurality of options.

9. The control system of claim 8, wherein
a content set in the work vehicle differs for each of the plurality of options; and
the controller is configured or programmed to cause the digital display to display setting content information indicating the content to be set in the work vehicle for each of the plurality of options.

10. The control system of claim 9, wherein the controller is configured or programmed to cause the digital display to display the setting content information such that a display position of the setting content information is adjacent to a display position of the corresponding option.

11. The control system of claim 4, wherein
the predetermined device is an engine controller configured or programmed to operate an engine and change a rotation speed of the engine; and
the controller is configured or programmed to:
cause the digital display to display an image to set the engine rotation speed; and
change the engine rotation speed according to an operation of the user to rotate the rotary selector.

12. The control system of claim 11, wherein the controller is configured or programmed to cause the digital display to display the engine rotation speed.

13. The control system of claim 4, wherein
the predetermined device is a transmission controller configured or programmed to operate a transmission and change a gear stage setting and/or sensitivity of the transmission; and
the controller is configured or programmed to:
cause the digital display to display an image to set the gear stage setting and/or sensitivity of the transmission; and
change the gear stage setting and/or sensitivity of the transmission according to an operation of the user to rotate the rotary selector.

14. The control system of claim 13, wherein the controller is configured or programmed to cause the digital display to display the gear stage setting and/or sensitivity of the transmission.

15. The control system of claim 4, wherein
the predetermined device is a wiper driver to operate a wiper;
the wiper driver is capable of changing a length of a stationary time that is a time during which the wiper is stationary between one operation of the wiper and the next operation thereof; and
the controller is configured or programmed to:
cause the digital display to display an image to set the stationary time; and
change the length of the stationary time according to an operation of the user to rotate the rotary selector.

16. The control system of claim 15, wherein the controller is configured or programmed to cause the digital display to display the length of the stationary time.

17. The control system of claim 15, wherein the controller is configured or programmed to:
cause the digital display to display a second graph with a value that increases or decreases along a circumference or an arc; and
change a display content of the second graph according to a change in the length of the stationary time.

18. A work vehicle comprising the control system of claim 1.

19. The work vehicle of claim 18, wherein the work vehicle is a mobile agricultural machine.

20. The work vehicle of claim 18, wherein the work vehicle is a tractor.

21. A computer-implemented control method to control a work vehicle executed by one or more computers, the method comprising:
causing a digital display of a meter panel to display a setting value of a predetermined device included in the work vehicle; and
when a user performs an operation of a selector to change the setting value, detecting a speed at which the selector moves by the user's operation, and changing an amount of change in the setting value per predetermined displacement amount of the selector according to the detected speed.

22. A non-transitory computer-readable medium including a computer program that causes one or more computers to execute control of a work vehicle, the computer program causing the one or more computers to perform:
causing a digital display of a meter panel to display a setting value of a predetermined device included in the work vehicle; and
when a user performs an operation of a selector to change the setting value, detecting a speed at which the selector moves by the user's operation, and changing an amount of change in the setting value per predetermined displacement amount of the selector according to the detected speed.
